(19) United States
(12) Patent Application Publication
(10) Pub. No.: US 2007/0143155 A1
(43) Pub. Date: Jun. 21, 2007

(54) System, method, and computer program product for reducing the burden on an inventory system by assembling a suggested themed travel itinerary in response to minimal user input

(75) Inventors: Troy Whitsett, Keller, TX (US); Fayyaz H. Shah, Garland, TX (US); Richard Webby, West New York, NJ (US); Laura Johnston, Coppell, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Travelocity.com LP.

(21) Appl. No.: 11/314,860

(22) Filed: Dec. 21, 2005

(51) Int. Cl. G06Q 10/00

(52) U.S. Cl. 705/5

(57) ABSTRACT

The present invention generates a concise listing of low-priced travel products in an interactive itinerary format in response to a simplified user input that may include specification of a selected travel theme. The interactive itinerary generated by the invention may allow the user to revise the itinerary to add, remove, and/or amend details related to the various travel products listed therein such that the user may be made aware of the cost and/or scheduling effects of making a particular revision to the itinerary. The invention may also provide a concise display of supplemental information related to the selected theme and/or a selected destination for the itinerary such that the user may be better informed when making revisions to the interactive itinerary. For example, the invention may provide interactive maps, reviews, photos, and/or other supplemental information related to the selected theme and/or one or more of the listed travel products.

### BACKGROUND OF THE INVENTION

1. Field of the Invention

The present invention relates to the field of mechanized inventory systems, such as airline reservations systems or other product and/or service reservation or inventory systems, which are used to determine availability and pricing for products and/or services. More particularly, the embodiments of the present invention are adapted to determine and display a themed travel itinerary comprising several available products and/or services such that a user may build and modify a themed travel itinerary in real-time around a skeleton itinerary including selected and suggested travel products having a selected theme. Embodiments of the present invention may provide suggested low-cost travel products to fill out a themed itinerary in response to a simplified user input and/or in response to a detected user profile.

2. Description of Related Art

Many of today's products and services are catalogued in computerized reservation or inventory systems. These systems may include simple or complex methodologies for maintaining inventory and providing product and/or service availability information. Either via direct access or remote access across a network, consumers can run queries and view availability information for selected products and/or services, as well as purchase or reserve such items. One example of such systems is a computerized reservation system (CRS). A CRS provides a communications network for travel agents and other consumers to access travel related information such as airline seat availability, hotel reservations, car rentals, event availability, leisure activities, etc. CRS systems have been in existence for a long period of time. Some of the current CRS systems are known or referred to under the following trade names and services marks: SABRE, AMADEUS, WORLDSPAN, SYSTEM ONE, APOLLO, GEMINI, GALILEO, and AXESS.

Consumer interaction with these systems has evolved in recent years. Initially, these systems were difficult to use and did not always provide the best solution to a consumer's query. For example, in the early stages, a consumer interested in booking airline tickets would input a desired flight itinerary with desired travel dates and times and possible selected class of travel. The CRS system would check availability for the dates and return with a fare price meeting the specific input dates and times requested. Although there were some algorithms in place to aid the consumer in finding the lowest-priced fare, these algorithms were typically geared more toward providing quick results with less computing time and resources than in finding the lowest priced fare. For example, some early product availability and booking algorithms used a method that would heuristically select a subset of itineraries from a larger pool of itineraries, price this subset, and select the lowest-priced fare from the subset for display to the consumer. While these early systems provided timely results and reduced processing load on the CRS, they did not always provide the best solution to the consumer.

In light of this, an algorithm was developed, (sometimes referred to as extended implicit enumeration algorithm), that could be used to efficiently determine the lowest fare for a particular flight itinerary. The algorithm used a k-shortest path schema that identified the lowest available fare that met a consumer's request and displayed this fare to the consumer. This algorithm is described more fully in U.S. patent application Ser. No. 09/421,895, filed on Oct. 21, 1999, entitled: Method and Apparatus for Searching for a Low Fare for Travel Between Two Locations, and published as a PCT application under Publication No. WO 01/29693; the contents of which are incorporated herein.

The extended implicit enumeration algorithm was a major step forward in efficiently determining the lowest fare price for a given itinerary; it does have a few slight drawbacks. Specifically, the algorithm was designed to provide a small number of low priced answers with minimal consideration of diversity. The consumer inputs a request, and the algorithm returns only the lowest fare meeting the request. Unfortunately, such a process may not provide the best solution to a consumer or may miss an opportunity to market different fares to a customer that may maximize profits for the supplier, while also meeting the consumer's goals. Thus, a system, method, and computer program product were developed to provide a plurality of low fare prices and different flight itinerary options for a given departure and return date combination, thereby allowing a user to view these different options and make a determination as to which fare and flight itinerary meets their goals as described more fully in U.S. Provisional Patent Application Ser. No. 60/573,546, filed on May 21, 2004, entitled, Systems, Methods, and Computer Program Products for Searching and Displaying Low Cost Product Availability Information for a Given Departure-Return Date Combination or Range of Departure-Return Date Combinations; the contents of which are also incorporated herein.

While conventional searching systems for products may provide a user with a multitude of different options in the form of a results listing, the options displayed by such systems are sorted by and include information corresponding to the user input. For example, the results of a search for low-cost airfares may, in conventional systems, include line-by-line listings of flight options that correspond to lowest-cost product options. However, conventional search systems are generally passive. That is, conventional search systems are merely responsive to particular user inputs, such as a particular search for low-cost airfare between a selected departure airport and a selected arrival airport on selected departure and return dates. Thus, while conventional systems may provide low cost flight itinerary options (and in extended cases, a low cost hotel reservation in conjunction therewith), such conventional search systems cannot provide suggested complete travel itineraries built around a themed vacation experience wherein the theme is, for example, activity-based (i.e., a SCUBA vacation) and/or destination based (i.e., a Broadway vacation planned around ticketed shows). Furthermore, while travel agencies and/or specialty travel providers have for many years offered themed vacation “experiences” these services are unable to provide themed interactive itineraries built around low-cost travel products stored in a plurality of inventory systems. Furthermore, even “package” deals offered by existing travel agencies often lack flexibility, and do not afford travelers the opportunity to customize with additional activities and/or other travel products selected from a plurality of travel product inventory systems. Furthermore, conventional search systems and/or travel agencies also lack the capability to show a traveler, in near real-time; the pricing change(s) caused by the addition and/or removal of selected travel products from a vacation itinerary. In addition, when selecting travel products to complete a travel itinerary, a traveler is often forced to select travel products without the benefit of prior knowledge of the geography, distances, street layout, and/or other logistical details of a destination.

For example, in planning a Broadway show vacation in New York City, a user may be more interested in building a special travel “experience” around some selected travel products (such as tickets to selected shows and/or reservations at a particular hotel) rather than traveling on a particular day. Furthermore, the traveler may be unaware of peculiarities of timing, geography, and/or transportation in New York and thus may be unable to secure a hotel that meets the traveler's expectations and still allows the traveler easy access to shows, restaurants, and/or other activities. Furthermore, because conventional search systems do not allow a user to build an itinerary around a suggested schedule (and to place a plurality of travel products in a visual itinerary) the traveler may be unable to properly schedule various activities within their vacation. For example, using conventional search systems, a traveler may reserve tickets for a show at 8:00 PM following a dinner reservation at their hotel's restaurant at 6:30 PM. Because, conventional search systems do not allow a traveler to place their travel product purchases within a visual itinerary (much less a map), the traveler may be forced to consult and plan their vacation in a separate calendar program and/or day planner in order to avoid conflicts and/or time pressures. Furthermore, conventional search systems do not allow a traveler to place selected low-cost travel products within a visual itinerary and simultaneously view the result of such selections on the total cost of the vacation. For example, the traveler may be unaware that a hotel may be available that meets their needs only 3 blocks from their most desired accommodations for $30 less per night. In addition, conventional search systems may be unable to show the traveler (via a map and calendar itinerary, the cost and timing results of changing reserved show tickets from an evening show time to a matinee show time.

These limitations in the current systems may create a burden on inventory systems. Specifically, since conventional search systems are not capable of displaying travel products for a themed vacation experience in a “skeleton” itinerary format and/or mapping the location of travel activities, airports, and/or hotels on a map of the destination, a user may be required to run multiple searches in order to find a travel product and/or set of travel products meeting the traveler's budget while still being logistically acceptable. For example, an elderly traveler may have limited mobility and may require extra time to travel between two locations in an urban environment. Thus, if such a traveler wishes to plan two activities in a single afternoon/evening period, the traveler may first select and reserve a first activity (such as a matinee show), however, if the show is not shown on a visual itinerary, the traveler may be unaware of the logistical difficulty of planning a 6:00 PM dinner reservation at a location across town from the theater. Furthermore, conventional search systems may be incapable of alerting the traveler of a hotel option, for example, that may be closer to a majority of the traveler's planned activities for only $10 more per night than the lowest-cost hotel option. Conventional search systems would require that the traveler complete a secondary search for rates in the second hotel (assuming the traveler even knew that the second hotel was in the same geographical area of the majority of their planned activities). Conventional search systems lack the capability of combining, in real-time, search capabilities for determining low-cost options for a variety of travel products, with an interactive visual itinerary and/or mapping system for showing the traveler the logistical and cost effects of making adjustments to a suggested themed itinerary. Furthermore, conventional search systems have no provision for searching for descriptive data corresponding to the selected travel theme much less displaying the descriptive data in response to a user search for a themed travel itinerary. Thus, travelers are forced to supplement their pricing research (via conventional search systems) with other information searches (public transport, reviews, and other supplemental information). While some conventional systems may provide links to such supplemental information, conventional systems do not integrate such data with a visual itinerary and supply it to a user in response to an initial user input. As such, the need for additional information places added burden on the inventory system to process additional requests for such information. In some instances, added systems are required to meet the demand.

Therefore, there exists a need for an improved system to solve the technical problems outlined above that are associated with conventional search systems. More particularly, there exists a need for a system for retrieving travel products from an inventory system corresponding to a selected theme such that a user may input relatively simple travel theme parameters (such as a destination and/or vacation activity type) and be proactively presented with a selection of suggested packages of travel options. There also exists a need for a system capable of displaying the retrieved travel products in an interactive visual itinerary format such that a user may view a virtual time line of their planned travel and make appropriate amendments as they see fit. There further exists a need for a system for displaying to the user, in real-time or near real-time, the immediate pricing consequences of amending, adding, and/or deleting travel products from the suggested itinerary generated by the system. Furthermore, there exists a need for a system that supplements the data shown in the visual interactive itinerary with other data (such as, for example, maps, destination history, reviews of activities and/or travel products generated by peer travelers, photographs). Finally, there also exists a need for a system capable of mapping travel product locations (including, for example, airports, hotels, theaters, recreation areas, golf courses) such that a user may be made aware of the cost and logistical considerations of changing the suggested itinerary to a slightly more expensive hotel, for example, that may be closer to the traveler's selected activities than a lower-cost hotel.

### BRIEF SUMMARY OF THE INVENTION

The needs outlined above are met by the present invention which, in various embodiments, also provides a system that overcomes many of the technical problems discussed above, as well other technical problems, with regard to the retrieval and concise display of travel product options displayed by conventional low-cost product search systems. Specifically, in one embodiment, the system of the present invention may be capable of assembling and displaying a travel itinerary comprising a plurality of travel products selected from a database based on a selected theme in a manner that reduces the burden on inventory systems. According to some embodiments, the system may comprise an inventory system comprising travel products, wherein for at least some of the travel products, the inventory system also comprises scheduling and/or location data corresponding to the travel products as well as theme data corresponding to the travel products. Furthermore, system embodiments of the present invention further comprise a host computing element in communication with the inventory system for running queries on the inventory system based on an initial user input, wherein the initial user input comprises a selected travel theme. The host computing element may, in some embodiments, retrieve travel products from the inventory system having theme data corresponding to the selected theme of the user input and subsequently and/or concurrently display the retrieved travel products corresponding to the selected theme. Furthermore, the host computing element may also display the retrieved travel products in an interactive itinerary based at least in part on the scheduling and/or location data (that may be associated with at least some of the retrieved travel products) and the selected theme so as to build and present to a user a “skeleton” visual itinerary that may be the basis of an economical yet highly-personalized themed vacation which the user can then adjust and personalize to their interests, schedule and budget needs. According to some additional system embodiments, the host computing element may further detect an idle time period within the interactive itinerary and display a suggested travel product in an interactive display (such as a “pop-up” text box) wherein the suggested travel product may have scheduling data substantially corresponding to the idle time period, so as to more completely “fill” idle time within the itinerary with suggested travel products that may also comply with the selected theme.

According to some system embodiments, the inventory system may further comprise pricing data representing a price corresponding to the travel products, and the host computing element may further display the price of the retrieved travel products in the interactive itinerary as well as a total price corresponding to the sum of the displayed prices of the retrieved travel products. Furthermore, in some embodiments, the display functions of the system of the present invention may also include the display of a plurality of interactive icons corresponding to each of the retrieved travel products displayed in the interactive itinerary. Furthermore, according to some such embodiments, the host computing element may further detect a user selection of at least one of the plurality of interactive icons and calculate and/or display the total price based on the sum of the displayed prices of the selected retrieved travel products. According to some embodiments of the system of the present invention, the host computing element may be programmed and/or configured to automatically search for travel products from the inventory system having the lowest price corresponding to the selected theme.

The host computing element may, in some additional system embodiments, be further adapted to receive a revising user input for revising at least a portion of the interactive itinerary. Furthermore, in some such system embodiments, the host computing element may further display a revised interactive itinerary in response to the received revising user input. For example, in some embodiments, the plurality of travel products may include hotel rooms, reserved show tickets, airline itineraries, recreational activity reservations (such as a golf tee time, for example), and/or car rental reservations. Thus, the revising input may comprise, in some embodiments a user manipulation of various travel product parameters including, but not limited to: the dates and times of the airline itinerary, the number of nights reserved in a particular hotel, the class of hotel, airline seating, car rental class, number of passengers, number of tickets for a given activity and/or show, the type of equipment rented for a particular recreational activity, and/or other parameters.

According to some system embodiments of the present invention, the host computing element may be further capable of “learning” certain aspects of a traveler's preferences by, for example, detecting an interest user input, the interest user input indicating a user interest (such as the reservation of several golf tee times, and/or multiple spa appointments). In response to the detection of such user interests, the host computing element may further display a suggested travel product in an interactive display in accordance with the indicated user interest (such as discounted greens fees at a nearby, but unselected, golf course with similar amenities to the booked course). According to some such embodiments, the host computing element may thus be capable of detecting an additive user input comprising a selection of the suggested travel product (such as the discounted golf course). The host computing element may then be capable of adding the newly-selected suggested to the interactive itinerary in response to the detected additive user input.

Furthermore, in some embodiments, the host computing element may be further capable of displaying the scheduling and/or location data corresponding to the retrieved travel products in an interactive map display such that a user may view the geographical and/or logistical consequences of amending the suggested interactive itinerary. Furthermore, the host computing element may also be capable of interrogating a plurality of electronic data sources comprising descriptive data corresponding to the selected theme, and displaying the descriptive data in response to the user input. The descriptive data may include, but is not limited to: information related to a destination; information related to travel arrangements; information related to reservations and/or rentals; information related to government-issued travel documents and/or advisories; and other descriptive data corresponding to the selected theme and/or travel products. The electronic data sources consulted by the host computing element may include, but are not limited to; an internet discussion board; an internet journal; a photo database; a mapping and/or directions website; a destination guide; a government website (such as, for example, a website for passport renewal and/or travel warnings); and/or combinations thereof.

Further, the present invention also provides methods and/or computer program products for assembling and displaying a travel itinerary comprising a plurality of travel products selected from a database based on a selected theme in a manner that reduces the burden on an inventory system. The inventory system may comprise travel products wherein, for at least some of the travel products, the inventory system also comprises scheduling and/or location data corresponding to the travel products and theme data corresponding to the travel products. According to some embodiments, the method comprises steps for: retrieving travel products from an inventory system based on an initial user input, wherein the initial user input comprises a selected theme; displaying the retrieved travel products having theme data corresponding to the selected theme; and displaying the retrieved travel products in an interactive itinerary based at least in part on the scheduling and/or location data and the selected theme for those retrieved travel products having scheduling and/or location data corresponding to the retrieved travel products. Other method and/or computer program embodiments may further comprise steps for detecting an idle time period within the interactive itinerary and displaying a suggested travel product in an interactive display (such as a text box, for example. The suggested travel product may further have scheduling data substantially corresponding to the idle time period, such that the method may seek to “fill” the interactive itinerary with additional travel products that may, in some cases also comply with the requirements of the selected theme.

In other method embodiments, the method may also comprise steps for displaying the price of the retrieved travel products in the interactive itinerary and further displaying a total price corresponding to the sum of the displayed prices of the retrieved travel products. According to some method embodiments, the method may comprise steps for: displaying a plurality of interactive icons corresponding to each of the retrieved travel products displayed in the interactive itinerary; detecting a user selection of at least one of the plurality of interactive icons; calculating the total price based on the sum of the displayed prices of the selected retrieved travel products; and displaying the calculated total price. According to various other method embodiments of the present invention, the method may also comprise steps for retrieving travel products from the inventory system having the lowest price corresponding to the selected theme.

Some method and/or computer program product embodiments further comprise steps for receiving a revising user input for revising at least a portion of the interactive itinerary and displaying a revised interactive itinerary in response to the received revising user input, such that a user may remove and/or add specific travel products to the itinerary and view the pricing and scheduling results of such revisions. In various method embodiments, receiving step may comprise receiving a revising input that may comprise a user manipulation of various travel product parameters including, but not limited to: the dates and times of the airline itinerary, the number of nights reserved in a particular hotel, the class of hotel, airline seating, car rental class, number of passengers, number of tickets for a given activity and/or show, the type of equipment rented for a particular recreational activity, and/or other parameters.

The method and/or computer program products of the present invention may also comprise additional steps for detecting an interest user input indicating a user interest, and, displaying a suggested travel product in an interactive display in response to the indicated user interest. Furthermore, some such method embodiments may further comprise steps for detecting an additive user input comprising a selection of the suggested travel product and displaying the selected suggested travel product in the interactive itinerary in response to the detected additive user input.

Additional method and/or computer program product embodiments of the present invention may also comprise steps for retrieving and displaying information related to the themed itinerary to a user such that the user may be better informed of the peculiarities of a specific destination prior to purchasing travel products and/or revising the interactive itinerary as above. For example, some method and/or computer program embodiments may further comprise steps for displaying the scheduling and/or location data corresponding to the retrieved travel products in an interactive map display. Other method and/or computer program embodiments may comprise steps for interrogating a plurality of electronic data sources comprising descriptive data corresponding to the selected theme, and displaying the descriptive data in response to the user input. According to various embodiments, the interrogating step described above may comprise interrogating a plurality of electronic data sources that may include, but are not limited to: internet discussion boards; internet journals; photo databases; government websites; mapping and/or directions websites; destination guides; and/or combinations thereof.

Thus the systems, methods, and computer program products for assembling and displaying a travel itinerary comprising a plurality of travel products selected from a database based on a selected theme, as described in the embodiments of the present invention, provide many advantages that may include, but are not limited to: generating a highly informative visual interactive itinerary that may show the relative scheduling details of a themed vacation experience; providing an interactive itinerary that may be instantaneously revised by a user such that the viewer may view the pricing and/or scheduling effects of the addition and/or deletion of travel products from the itinerary; providing mapping and supplemental destination information to the user in response to a selection of a “theme” vacation or travel experience such that the user may be more capable of making informed decisions when revising and/or refining the itinerary; and providing “adaptive” features wherein the user is presented with suggested travel products and/or travel product discounts based at least in part on the perceived and/or detected interests of the user as they revise the itinerary.

These advantages and others that will be evident to those skilled in the art are provided in the system, method, and computer program product of the present invention. Importantly, all of these advantages allow the system to display results to a user in a highly-informative, but compact visual itinerary. Since individual travel products, their prices, and/or their positions relative to a calendar are made readily visible to the user in a compact format, the user is less likely to run multiple queries for product options in order to refine the itinerary and/or determine the cost effects of an itinerary revision that can overburden the inventory system.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIGS. 1A and 1B illustrate a typical network environment in which the systems, methods, and computer program products may be implemented according to one embodiment of the present invention;

FIG. 2 is a graphical depiction of a display generated according to one embodiment of the present invention for receiving a user input such as a selected departure city and/or selected travel dates;

FIG. 3 is a graphical depiction of a display generated according to one embodiment of the present invention for receiving a user input such as a selected travel theme;

FIG. 4 is a graphical depiction of a display generated according to one embodiment of the present invention for displaying one or more suggested travel dates corresponding to an interactive itinerary;

FIG. 5 is a graphical depiction of a display generated according to one embodiment of the present invention for displaying an interactive itinerary populated with travel products corresponding to a selected theme;

FIG. 6 is a graphical depiction of a display generated according to one embodiment of the present invention for receiving a revising user input such as a selection of an entertainment travel product;

FIG. 7 is a graphical depiction of a display generated according to one embodiment of the present invention for displaying a suggested travel product based at least in part on an indicated user interest;

FIG. 8 is a graphical depiction of a display generated according to one embodiment of the present invention for receiving a revising user input such as a selection of a hotel;

FIG. 9 is a graphical depiction of a display generated according to one embodiment of the present invention for displaying descriptive data corresponding to a selected theme;

FIG. 10 is an illustration of the operation flow of the systems, methods, and computer program products in response to a user input including retrieval, display and interactive itinerary display steps, according to one embodiment of the present invention;

FIG. 11 is an illustration of the operation flow of the systems, methods, and computer program products in response to a user input including retrieval, display, interactive itinerary display, price display, and total price display steps, according to one embodiment of the present invention;

FIG. 12 is an illustration of the operation flow of the systems, methods, and computer program products in response to a user input including retrieval, display, interactive itinerary display, receiving a revising user input and revised interactive itinerary display steps, according to one embodiment of the present invention;

FIG. 13 is an illustration of the operation flow of the systems, methods, and computer program products in response to a user input including retrieval, display, interactive itinerary display, detecting a user interest, and suggested travel product display steps, according to one embodiment of the present invention;

FIG. 14 is an illustration of the operation flow of the systems, methods, and computer program products in response to a user input including retrieval, display, interactive itinerary display, detecting a user interest, suggested travel product display, detecting an additive user input, and displaying the suggested travel product in an interactive itinerary steps, according to one embodiment of the present invention;

FIG. 15 is an illustration of the operation flow of the systems, methods, and computer program products in response to a user input including retrieval, display, interactive itinerary display, and interactive map display steps, according to one embodiment of the present invention; and

FIG. 16 is an illustration of the operation flow of the systems, methods, and computer program products in response to a user input including retrieval, display, interactive itinerary display, interrogating an electronic data source, and descriptive data display steps, according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The various aspects of the present invention mentioned above, as well as many other aspects of the invention are described in greater detail below. The systems, methods, and computer program products of the present invention are described with respect to one or more destination themed itineraries centered in the city of Las Vegas, Nevada. However, it must be understood that this is only one example of the use of the present invention. Specifically, the systems, methods, and computer program products of the present invention can be adapted to present interactive itineraries directed to various travel themes, user preferences, selected “experiences,” and/or destinations. For example, the interactive itineraries of the present invention may include travel products as part of an outdoor adventure theme for a destination such as Aspen, Colo. In addition, interactive itineraries may include travel products as part of an historical travel theme, such as a Revolutionary War trip to Boston and surrounding areas. In other examples, the interactive itineraries may be built around a user profile which may indicate a user's interest in “adventure” travel, travel to a specific area of the world, and/or other user preferences that indicate a user's interest in certain travel “experiences.” As used herein, the term “theme” and/or “selected theme” may refer generally to a type of travel product directed towards a selected type of traveler that may have somewhat predictable travel product preferences. Traveler types (and corresponding “themes”) may include, but are not limited to: an adventurous traveler, a family, a couple without children, a honeymooning couple, a single traveler, a first-time visitor to a selected destination, a history enthusiast, an outdoors enthusiast, a runner, a cyclist, and/or other traveler types and/or themes. In addition, selected themes may also be defined by a travel destination that may be known for a particular type of travel product travel activity, and/or travel “experience”. For example, a Nashville-themed itinerary may include primarily music and/or country music related travel activities.

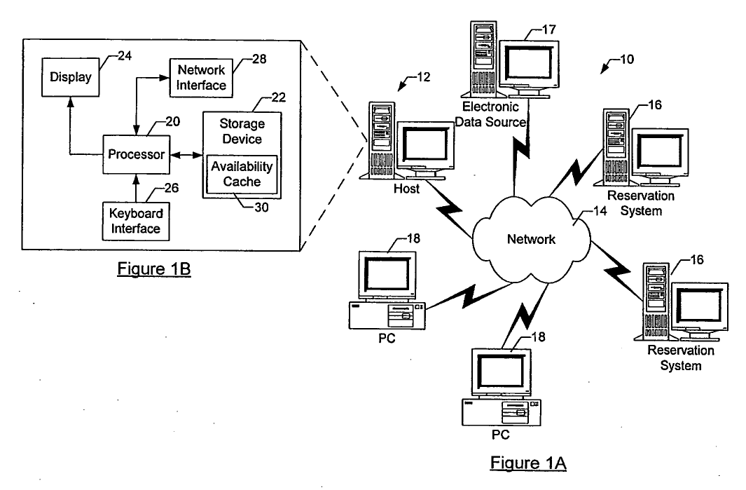

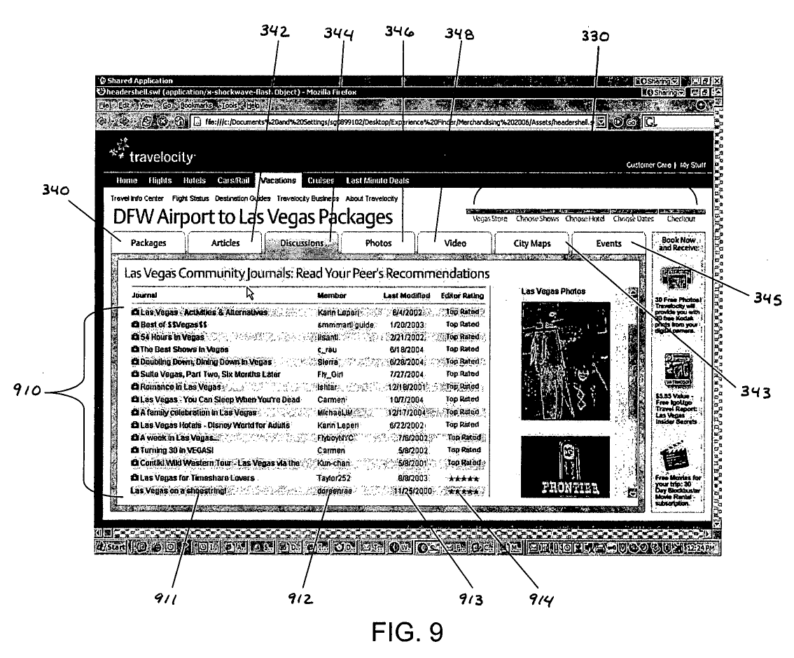

FIGS. 1A and 1B illustrate an example of a typical conventional network environment 10 in which the systems, methods, and computer program products of the present invention may be employed. The network includes a host computer 12 that operates a web site or other similar customer interface. The host computer is typically connected to a network 14, such as a LAN, WAN, Intranet, or Internet, for example. Also connected to the network are various reservation systems 16 containing itineraries, fare information, and availability information for various products sources, such as hoteliers, airlines, car rental companies, etc. Further, users are also connected to the network via personal computers 18 or other types of computing systems. In addition, one or more electronic data sources 17 (such as, for example server computers hosting websites, online databases, or other electronic resources accessible via the network 14) may also be connected to the network 14 such that the host computer 12 may be capable of interrogating the electronic data sources 17 so as to be capable of displaying descriptive data retrieved from the electronic data sources 17 (as shown generally in FIG. 9 (showing a discussion tab 344 directed to “Las Vegas” travel journals).

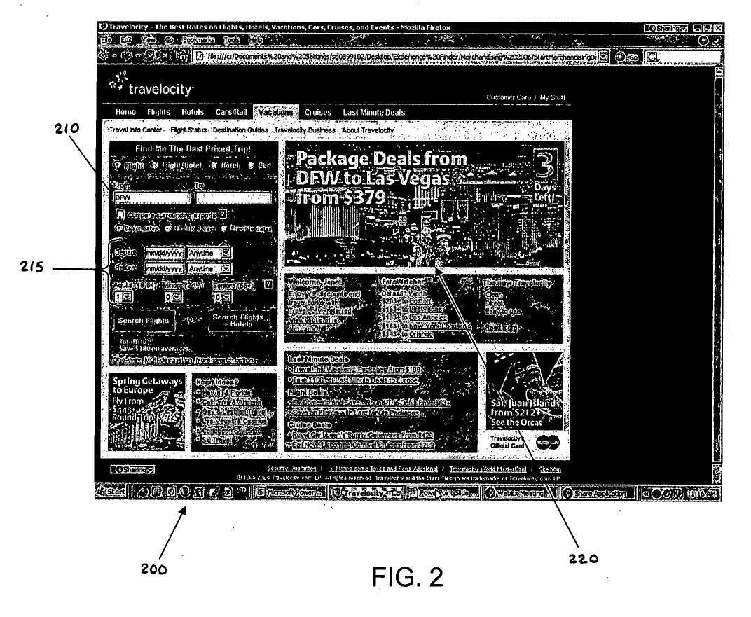

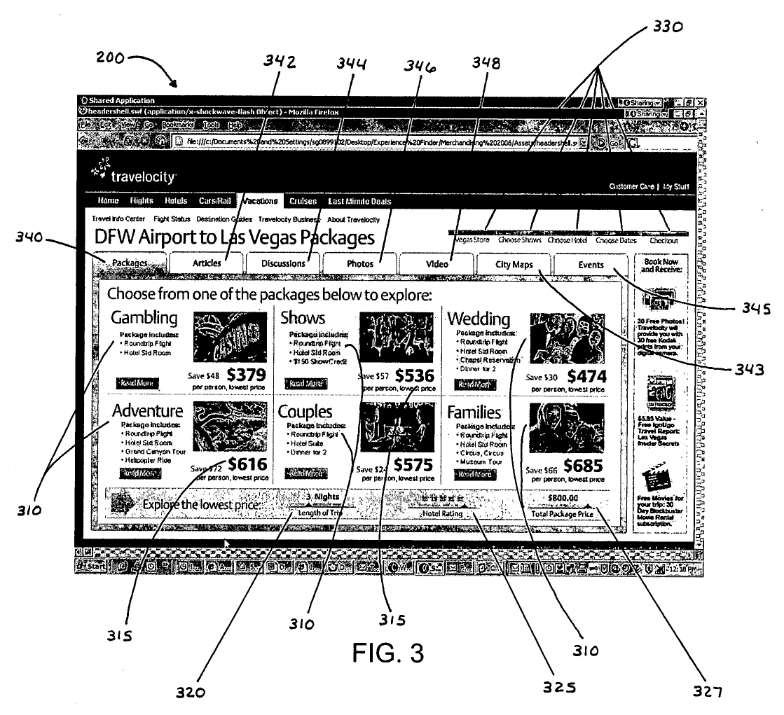

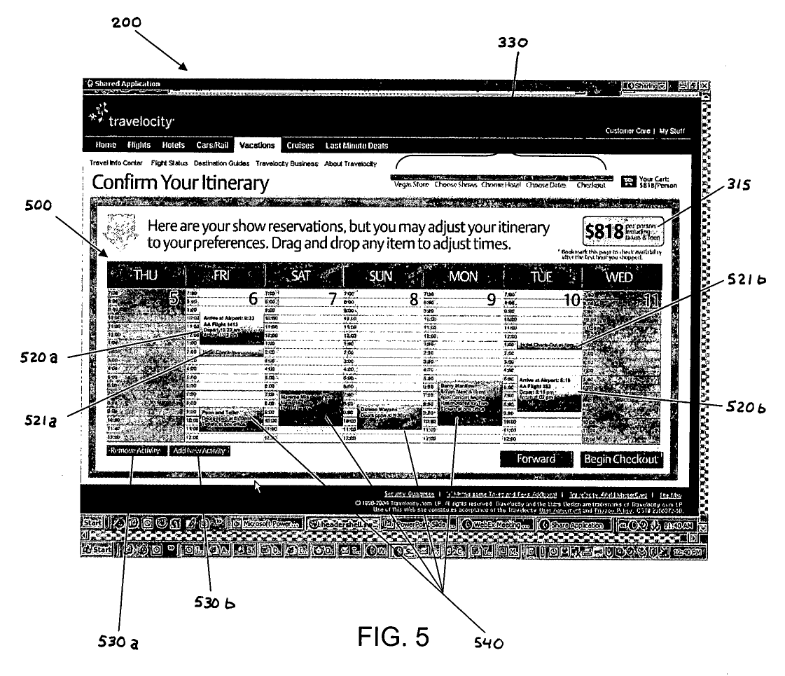

In operation, the system of the present invention, via the host computer 12, provides a web page or other similar electronic form to the user. Using the web page, the user inputs a travel related query (see FIGS. 2 and 3, for example). Based at least in part on this query, which may include the input of a selected destination (see element 210, FIG. 2) and/or the designation of a selected theme (see elements 310, FIG. 3) that may correspond to the selected destination, the host computer 12, in turn, polls the reservation systems 16 of the product providers to assemble and display a suggested interactive itinerary 500 (see FIG. 5, for example) including a plurality of travel products having theme data that corresponds to the selected theme 310. The travel products may include not only airline itineraries, hotel reservations, and/or car rental reservations, but also entertainment and/or outdoor activity reservations for activities that may correspond, for example, to the selected theme 310 of the interactive itinerary 500. The host computer 12 may also be capable of detecting scheduling and/or location data corresponding to the various travel products retrieved from the reservation systems 16. Such scheduling and/or location data may include, but is not limited to: the location of airports, hotels, entertainment venues, sports venues, outdoor recreation centers, schedule information for shows, transportation, and/or flights or other data that may be stored in the reservation system 16 that corresponds to the travel products. For those retrieved travel products having scheduling and/or location data associated therewith, the host computer 12 may then assimilate the results of the queries and provide them in a display 200 (see FIGS. 2-8, for example) or other electronic form to the user via a website, for example). The display 200 (as shown in FIG. 5) may include a interactive itinerary 500 based at least in part on the scheduling and/or location data as well as the selected theme 310 for the interactive itinerary 500. Other system embodiments of the present invention may also retrieve (from alternate electronic data sources 17 (as described further below)) substantially simultaneously to the retrieval of the travel products, for example, all relevant community discussion board reviews and content related to the query as well as all multimedia content related to the retrieved travel products and/or the selected theme. Such multimedia content, may include, but is not limited to: related articles, professional travel reviews, photos, 360 views, videos, and combinations thereof.

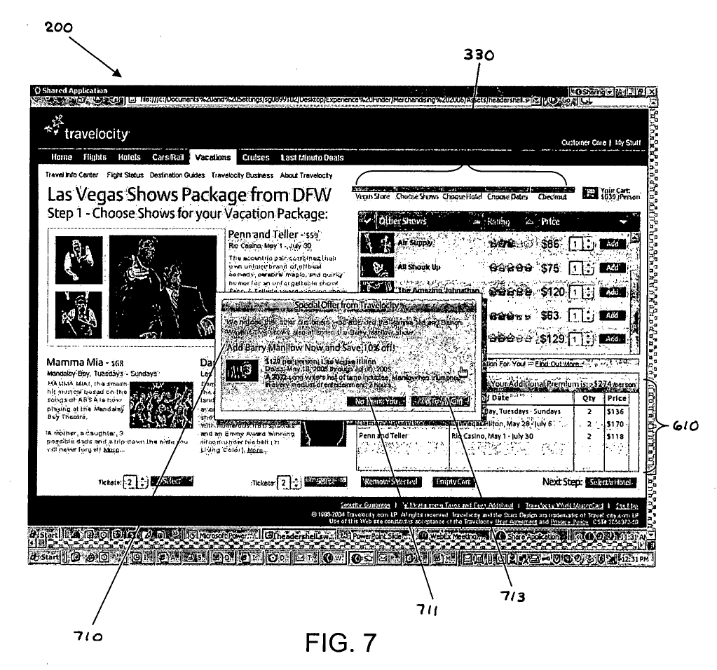

According to some system embodiments of the present invention, the host computer 12 may further detect an idle time period within the interactive itinerary 500 (see FIG. 5) and display a suggested travel product in an interactive display (such as a text box similar to the “pop-up” graphic shown generally as element 710 in FIG. 7). In some embodiments, the suggested travel product may have scheduling data substantially corresponding to the idle time period. Thus, the host computer 12 may be capable of querying the user (using a text box) to see if the user may wish to add one or more travel products to fill otherwise idle time slots within the interactive itinerary 500. For example, as shown in FIG. 5, the host computer 12 may propose (via a text and/or “pop-up” graphic), a suggested travel product (such as, for example, a dinner reservation prior to the show reservation 540 shown generally on “Sunday the 8^{th}”) to fill a detected idle time period within the interactive itinerary 500. Furthermore, the host computer 12 may comprise pre-programmed logic (stored in the storage device 22, for example) so as to be capable of proposing a suggested travel product that may be appropriate for detected idle time periods. For example, the host computer 12 may only present suggested outdoor recreation travel products during daylight hours. Furthermore, the host computer 12 may propose restaurant reservations only during conventional meal time hours.

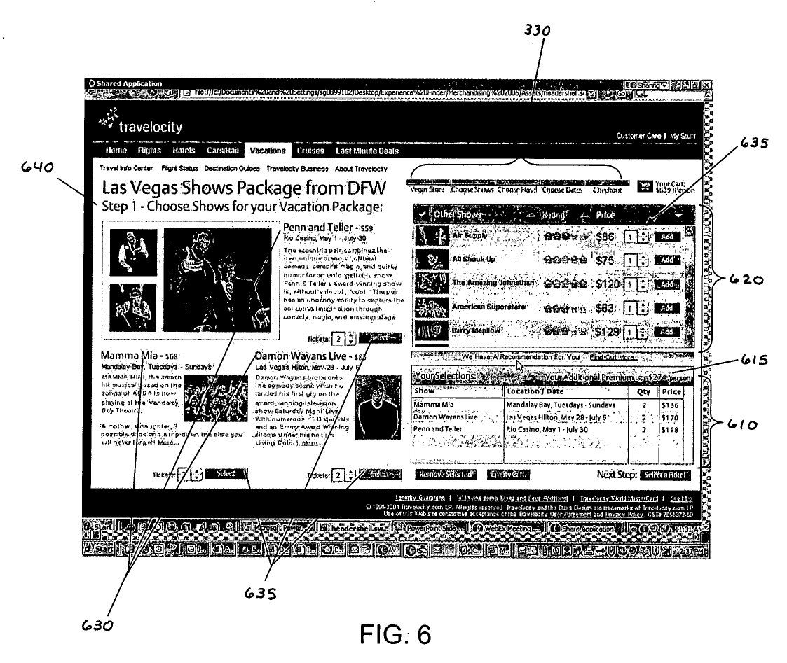

In some system embodiments, the reservation system 16 may also comprise pricing data representing a price corresponding to one or more of the travel products. According to such embodiments, the host computer 12 may also retrieve and display the individual price of each retrieved travel product (see FIG. 6, element 610 depicting a “shopping cart” of selected travel products with corresponding prices associated therewith). The host computer 12 may also be capable of displaying a cumulative price 315 corresponding to the sum of the individual prices of all of the travel products within a given interactive itinerary 500 (see element 315, FIGS. 3-5). According to some embodiments of the present invention, the cumulative price 315 may be updated in response to revising user inputs that may be received by the host computer 12 from the user in order to customize and/or amend the interactive itinerary 500. Thus, a user may, in some system embodiments, be kept aware of the cumulative price 315 of a given interactive itinerary 500 at all times throughout the search and reservation process such that the cost impact of a given addition and/or deletion of a travel product from the interactive itinerary 500 may be made immediately apparent via the display 200. For example, in some embodiments of the system of the present invention, the interactive itinerary 500 generated by the host computer 12 (and shown to a user via the display 200) may include the display of a plurality of interactive icons corresponding to each of the retrieved travel products shown in the itinerary 500. The host computer 12 may be adapted to detect a selection of one or more of the interactive icons and to calculate and update the display to display the cumulative price 315 of the interactive itinerary based on the sum of the displayed prices of the selected travel products. Furthermore, as shown generally in FIG. 5, the display 200 of the interactive itinerary 500 may include a “remove activity” button 530a and an “add new activity” button 530b such that a user may input a revising user input to add and/or remove a travel product from the interactive itinerary 500. As described generally above, the host computer 12 may be adapted to simultaneously update the display of the cumulative price 315 based on the removal and/or addition of travel products using the remove 530a and add new 530b activity buttons that may be provided as part of the display 200. Furthermore, as shown generally in FIG. 5, the user may also input a revising user input that may include “click and drag” computer mouse operations for moving various travel products to alternate dates and /or times within the interactive itinerary 500. According to various other embodiments, as described in further detail herein, the revising user input may also be received by the host computer 12 via a number of different graphical user interface tools, which may include, but are not limited to: slider bars, drop-down menus, check boxes, and combinations thereof.

In order to provide interactive itineraries 500 having the lowest possible cumulative price 315 while still satisfying the selected theme 310 indicated by a user input, the host computer 12 may retrieve travel products from the reservation system 16 having the lowest possible individual prices. For example, as shown generally in FIG. 3, the host computer may generate a display 200 comprising a listing of travel themes 310 (such as various themed Las Vegas vacations available from Dallas-Fort Worth International Airport) in response to a user input comprising the selection of a departure airport (see element 210, indicating that the user wishes to depart from Dallas-Fort Worth International Airport. According to other system embodiments, the host computer 12 may receive a simple user indication that the user would like to visit Las Vegas and the host computer 12 may build the interactive display and itinerary accordingly. For example, the host computer 12 may be capable of automatically determining a user's location (for example, near the Dallas-Fort Worth airport) from a stored profile (that may be stored, for example, in a storage device 22 in communication with the host computer 12). Other data within such a user profile may also include, but is not limited to: user preferences, user selected “experiences,” a user “experience wish list” (such as the desire to SCUBA dive and/or skydive). This supplementary data contained within a stored “user profile” may also be used by the host computer 12 to build a skeleton itinerary and for suggesting additional travel products (as described in further detail below) to fill out a complete “experience” that is tailored to the user's unique preferences.

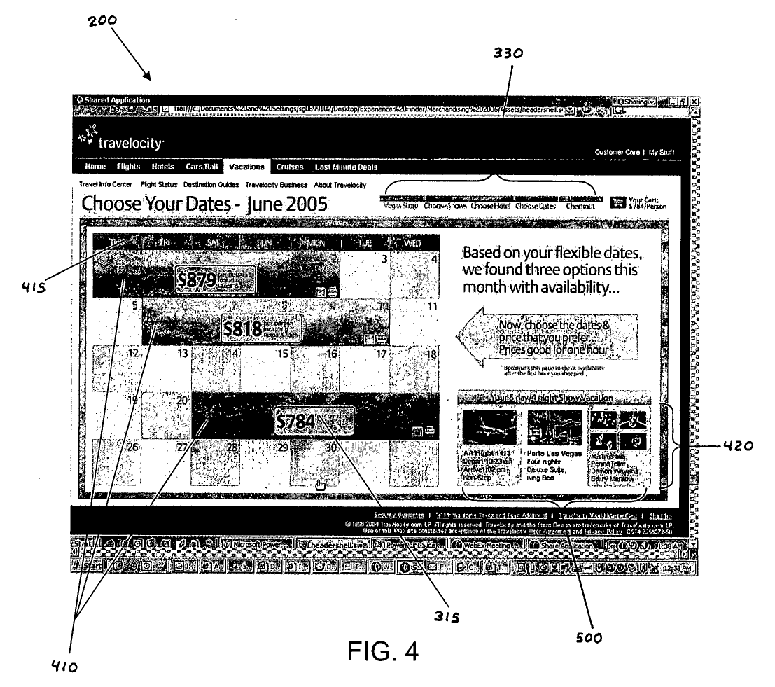

For each theme 310, the host computer 12 may build a lowest-cost interactive travel itinerary 500. For example, the “gambling” theme 310 may include a round-trip flight itinerary and a standard hotel room, both of which may represent the lowest costs for each travel product available from one or more reservation systems 16. According to another lowest cost example shown generally in FIG. 3, the “adventure” theme may comprise the hotel and flight reservations described above in conjunction with, for example, a Grand Canyon tour reservation and a helicopter tour reservation. For inventory systems 16 comprising pricing data corresponding to the travel products, the host computer 12 may retrieve travel products from the lowest-cost provider (as indicated via the reservation systems 16) for each individual travel product in order to assembly a base interactive itinerary 500 that may be further revised by the user (as described in further detail below). According to some embodiments, the lowest-cost travel products may be retrieved using a low-price search algorithm and/or search system such as that disclosed in U.S. Provisional Patent Application Ser. No. 60/573,546, filed on May 21, 2004, entitled, Systems, Methods, and Computer Program Products for Searching and Displaying Low Cost Product Availability Information for a Given Departure-Return Date Combination or Range of Departure-Return Date Combinations; which is incorporated by reference herein in its entirety. If the initial user input (such as the designation of a selected theme 310 and/or a departure city 210, does not include selected dates for travel, the host computer 12 may assemble one or more proposed travel times for the interactive itinerary 500 corresponding to the lowest cost availability for travel products corresponding to the user input (such as, for example, a selected theme 310 and/or departure city 210). The display 200 generated by the host computer 12 may thus, as shown generally in FIG. 4, display several proposed travel dates 410 relative to a one-month calendar 415 along with cumulative prices 315 corresponding to each proposed travel date 410. As shown in FIG. 4, the display 200 of several proposed travel dates 410 may also be displayed concurrently with the retrieved travel products 420 that make up the components of an interactive itinerary 500. As described in detail further below, the host computer 12 may be adapted to receive one or more revising user inputs and update the display 200, the interactive itinerary 500, and/or a cumulative price 315 associated therewith in response to the input of the revising user inputs.

As described above, the host computer 12 of the system embodiments of the present invention may be capable of assembling, in some embodiments, a proposed interactive itinerary 500 in accordance with the input of only a selected theme 310. Thus, a user may simply input a selected theme 310 and system embodiments of the present invention may be capable of suggesting a lowest-cost interactive itinerary 500 including travel products that not only meet the requirements of the selected theme 310, but also provide a lowest-cost interactive itinerary 500. As shown, for example, in FIG. 3, the system embodiments of the present invention may also present to the user (via a display 200) a group of suggested travel themes 310 for a selected destination. The various themes 310 may comprise various travel products, such as airline itineraries and hotel reservations, as well as credits for purchasing additional activity-based travel products. For example, as shown in FIG. 3, the “shows” theme 310 comprises a round-trip flight itinerary, a standard hotel room, and $150 in “show credit” that may be used to purchase tickets to a show of the user's choice. The cumulative price 315 associated with the “shows” theme 310 may be based upon the lowest cost for each of these travel products, as described generally above. However, in order to select a particular hotel, a particular airline, and/or to purchase show tickets using the “show credit” included as part of the suggested “shows” theme 310, the host computer 12 of the present invention may further receive a revising user input for revising at least a portion of the interactive itinerary 500. Furthermore, the host computer 12 may further display 200 a revised interactive itinerary 500 in response to the received revising user input. For example, as shown in FIG. 3, the display may comprise one or more slider bars 320, 325, 327 for receiving a revising user input comprising changing a length of the itinerary, changing the class of the hotel (i.e., the “star” rating of the hotel), and/or changing an upper limit on the cumulative price 315 of the itinerary 500. The display may also, in other embodiments, include other input devices including but not limited to: drop-down menus, check boxes, drag-and-drop menus, and other graphical interfaces for receiving a revising user input. As described above, the host computer 12 of the present invention may be capable of simultaneously re-calculating and displaying a revised cumulative price 315 based on the received revising user input such that the user may be informed in real-time of the cost and logistical effects associated with the revision to the interactive itinerary 500.

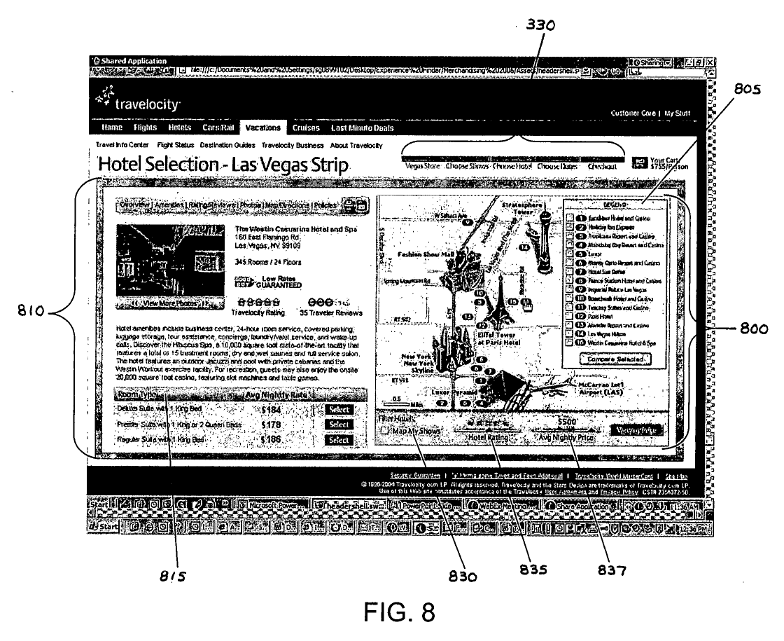

The revising user input may comprise, in some embodiments, a user input for selecting and/or changing a hotel reservation. As shown in FIG. 3, the steps of the overall process for refining an interactive itinerary 500 according to a user's particular preferences (including, for example entering various revising user inputs) may be navigated using a series of process buttons 330 that may be shown via the display 200. In some embodiments, the process buttons 300 may be customized for interactive itineraries corresponding to a particular selected theme 310. For example, the process steps for refining the interactive itinerary 500 for a Las Vegas “shows” vacation may involve a “choose hotel” step (wherein the revising inputs may be received via an interactive display 200 as shown generally in FIG. 8) For example, as shown generally in FIG. 8, the host computer 12 may be capable of generating a display 200 comprising hotel details and/or pricing options based on listed room types 815 at a particular suggested hotel 810 that may correspond, for example, to the lowest cost travel product in the interactive itinerary 500. As described in further detail below, the display 200 may further comprise an interactive map display 800 for displaying hotel options (using location data retrieved from one or more reservation systems 16, for example) relative to a city map of Las Vegas. As described further below, the interactive map display 800 may further comprise a mapping option button 830 wherein a user may choose to map one or more shows or other travel products relative to the various hotel options available at a given price point. Furthermore, in some embodiments, the interactive map display 800 may also comprise a hotel rating input button 835 and an average nightly price input button 837 for selecting and displaying (via the interactive map display 800, for example) a broader range of hotel options than those corresponding to the lowest-cost option that may be provided in the primary interactive itinerary 500. Furthermore, in some embodiments, the revising user input may comprise the selection of a higher hotel class (by actuating the hotel rating input button 835, for example) and the host computer 12 may be capable of searching for and retrieving (from one or more reservation systems 16) the lowest-cost travel product available in the higher hotel class. As shown in FIG. 8, the revising user input for revising the interactive itinerary to select a specific hotel may include, but is not limited to: a selection of a number of guests; a selection of a hotel room class (via, for example, the selection of a room type 815); a selection of a number of nights (see element 320, FIG. 3); a selection of a hotel company; a selection of a hotel class (via, for example, the actuation of the hotel rating input button 835); a selection of hotel amenities (such as, for example, pool, gym, high-speed internet, etc.), and combinations of the above-listed revising user inputs.

According to other embodiments of the present invention, the revising user input may comprise a user input for selecting and/or changing a reservation for one or more ticketed entertainment events, such as a live show. As discussed above, the process for entering revising user inputs may be tailored for a selected theme 310. For example, the process steps for refining the interactive itinerary 500 for a Las Vegas “shows” vacation theme 310 may involve a “choose shows” step (see generally, the process buttons 330 for navigating the revising input steps for finalizing a “shows”-themed interactive itinerary 500) wherein the revising inputs may be received via an interactive display 200 as shown generally in FIGS. 6 and 7. For example, as shown generally in FIG. 6, the display 200 may include an informational display 640 including synopses and/or photos corresponding to one or more show options 630 that may be available for purchase using, for example, “show credit” that may be offered as a travel product in a “shows”-themed interactive itinerary 500.

The display 200 for receiving a “shows”-specific revising user input may include a listing of available shows (corresponding, for example, to a selected travel date and/or proposed travel dates 410 (see FIG. 4, as discussed generally above), that may be purchased using “show credit” and/or by increasing the cumulative price 315 of the interactive itinerary 500. As shown in FIGS. 6 and 7, the display 200 may further comprise a “shows” shopping cart 610 for listing shows (or other entertainment events or travel products) selected by the user via previous revising user inputs. The shopping cart 610 portion of the display 200 may further comprise a status display 615 for informing a user of the balance of “show credit” remaining (in cases wherein the travel products in the shopping cart 610 have individual prices that, in sum, are less than the apportioned “show credit). As shown in FIG. 6, the status display 615 may also indicate the premium owed by the user (i.e., the cost exceeding the quoted cumulative price 315 of the primary interactive itinerary (see element 315, FIG. 3) due to the selection of shows (or other travel products) that exceed the allotted “show credit.” As described above with respect to the cumulative price 315 of the interactive itinerary, the host computer 12 may also be capable of updating the shopping cart 610 and/or status display 615 of the “shows” display in accordance with revising user inputs (received via a number of show selection buttons 635 that may be displayed adjacent to corresponding show options 630).

According to some system embodiments of the present invention, revising user inputs for “shows”-themed interactive itineraries may include, but are not limited to: a selection of a number of tickets; a selection of a show time for the show; a selection of a show; a selection of a class of ticket (i.e., preferred seating and/or reserved seating where available); and combinations of the above. Revising user inputs for shows and/or other ticketed and/or scheduled travel products may also be automatically placed in the interactive itinerary 500 by the host computer 12 using the scheduling and/or location data retrieved from one or more reservation systems 16, as discussed above. Furthermore, in some system embodiments, the host computer 12 may comprise a storage device 22 (such as a computer memory device) for storing location and/or scheduling data corresponding to one or more of the shows (or other travel products) selected via a revising user input such that during a subsequent “choose hotel” step (see discussion of FIG. 8, above) a user may elect to map one or more of the show locations (stored, for example, in the storage device 22) relative to one or more hotel options via an interactive map display 800. Furthermore, the host computer may store (via the storage device 22, 20 for example) scheduling data corresponding to one or more of the selected shows so as to be capable of accurately adding and displaying the selected shows in the interactive itinerary 500 (see element 540, FIG. 5).

According to other system embodiments of the present invention, the host computer 12 may be capable of receiving other revising user inputs for making similar selections for reservations for other travel products, such as recreational activities. The revising user inputs for recreational activities may include, but are not limited to: a selection of an equipment rental; a selection of an activity date and time; a selection of a number of people; and combinations of such revising user inputs. As described above with respect to the shows and hotel examples, the host computer 12 may be capable of retrieving location and/or scheduling data (from one or more reservation systems 16, via a network 14, for example) corresponding to travel products including recreational activities and displaying the travel products in an interactive map display 800 relative to other travel products having associated location data.

Furthermore, according to some system embodiments, wherein the travel products comprise airline itineraries (for traveling to the selected destination represented in the selected theme 310, for example), the revising user input may include, but is not limited to: a selection of a number of passengers; a selection of a departure date; a selection of a departure time; a selection of a return date; a selection of a return time; a selection of a departure location; a selection of a destination; a selection of an airline; a selection of a seating class; a selection of a fare code; and combinations of these airline itinerary revising user inputs. Because the departure date and return date options may heavily impact the assembly of an interactive itinerary 500 (due to the fact that many travel products assembled by the embodiments of the present invention are scheduled events that are subject to change depending on the dates of travel), the revising user inputs for amending details of an airline itinerary may, in some system embodiments, be received by the host computer 12 at or near a beginning of the interactive itinerary 500 refinement process (outlined, for example, by the process buttons 330 displayed in FIG. 3). For example, as shown in FIG. 2, the initial user input may include departure and return dates for travel during a selected timeframe. However, in some embodiments, the present invention may include a display 200 for receiving revising user inputs for revising one or more details of a flight itinerary during the course of the refinement of the interactive itinerary. Because the host computer 12 may store (in a storage device 22 and/or a data cache 30 thereof, for example) scheduling and/or location data corresponding to all of the various retrieved travel products included in a particular interactive itinerary, the host computer 12 may be capable of instantaneously adjusting and reconfiguring the interactive itinerary 500 (including the cumulative price 315 thereof) in response to a revising user input as basic as a change in the itinerary dates (as dictated by a revising user input for changing at least one portion of a flight itinerary).

In addition, in some embodiments, the travel products within the interactive itinerary 500 may also include a car rental reservation. In such system embodiments, the host computer 12 may be further capable of receiving a revising user input that may include, but is not limited to: a selection of a car rental pick-up date; a selection of a car rental drop-off date; a selection of a car rental pick-up location; a selection of a car rental drop-off location; a selection of a car class; a selection of car rental company; an combinations of these car rental-specific revising user inputs. Because the parameters of a car rental reservation may relay heavily on a corresponding flight itinerary, the host computer 12 of the system of the present invention may be capable of, for example, populating the interactive itinerary 500 with car-rental pick-up and car rental drop-off times that may be scheduled automatically (utilizing, for example, location and/or scheduling data retrieved from one or more reservation systems 16 via a network 14) such that a user may be directed to return the car rental in ample time to navigate the departure airport security and/or traffic in time to make a scheduled return flight. Because, the host computer 12 may be capable of storing (via the storage device 22, for example) and/or updating the interactive itinerary 500 in near-real time in response to the revising user inputs, a user may be kept constantly informed of the scheduling (and cost) impacts of a particular revising user input. Similarly, as shown generally in FIG. 5, elements 521a, 521b, the host computer 12 may also be capable of automatically displaying hotel check-in and check-out times in the interactive itinerary 500 using scheduling data (retrieved from one or more reservation systems 16) that may be unique to the particular hotel selected. Thus, using the interactive itinerary 500 (and its near-real time updates) a user may more accurately and easily select a hotel having a relatively late check-out so as to have the opportunity to sleep in prior to a long day of travel.

According to some system embodiments of the present invention, the host computer 12 may store (in an integrated storage device 22, for example), a plurality of revising user inputs corresponding to a particular user (identified, for example, by a unique login identifier and/or password) so as to be capable of identifying particular user preferences and thereby “learning” the user's preferences. Thus, the host computer 12 may be more capable of tailoring a suggested interactive itinerary 500 to the user's preferences and anticipating the user's revising user inputs. For example, the host computer 12 may be capable of analyzing a particular user's stored revising user inputs to reveal a preference for a particular hotel company, even if that hotel company is not the lowest-cost provider as determined by the host computer 12 interrogation of one or more reservation systems 16. Thus, for the specific user, the host computer 12 may alter the assembly of the interactive itinerary 500 to favor hotels within the user's preferred hotel company.

In addition, and as shown generally in FIG. 6 the host computer may also be capable of storing more short-term preferences, such as, for example, a repeated selection of an informational display 640 corresponding to a particular show option 630. The host computer 12 may be capable of storing such selections (which may include, but are not limited to, computer mouse clicks and/or selections using pull-down menus or interactive icons (such as check boxes) in order to determine a user's predicted interest in a particular travel product. Thus, in some system embodiments, the host computer 12 may be capable of detecting an interest user input (such as, for example, a selected number of mouse clicks corresponding to a particular travel product that may indicate a user interest in the travel product). Furthermore, the host computer 12 may further be adapted to display a suggested travel product in an interactive display in accordance with the detected user interest. In some instances, the detected user interest may also be linked to an interest user input directed towards a travel product related to the suggested travel product. For example, as shown in FIG. 6, the host computer may be capable of detecting an interest user input comprising the selection of a first show. The host computer 12 may be capable (by consulting a data cache 30 and/or storage device 22) of determining that a majority of users who selected the first show also indicated interest and/or selected a second show. Therefore, as shown in FIG. 7, the host computer 12 may display the second show as a suggested travel product in an interactive display 710 that may comprise one or more user input buttons 711, 713 for declining or selecting, respectively, the suggested travel product. In addition, the host computer 12 may be further adapted to receive an additive user input (such as the actuation of the “acceptance” user input button 713 and to subsequently update the interactive itinerary 500 (and/or the “shows” shopping cart 610) to display the suggested travel product (the second show, for example) in the interactive itinerary 500 in response to the detected additive user input. Furthermore, the host computer 12 may also be capable of storing (in the storage device 22, for example) the user's response to the suggested travel product for use in developing the presentation of suggested travel products to other users.

As shown generally in FIG. 1B, the host computer 12 of the system embodiments of the present invention may be in communication (via a network 14, for example) with one or more electronic data sources 17 comprising descriptive data corresponding to a selected theme 310. According to some system embodiments, the host computer 12 may further present the descriptive data to a user via the display 200, as shown generally in FIG. 9. For example, as discussed above, the initial user input may comprise the selection of a theme 310 that may be based on a selected destination (such as Las Vegas). Thus, in response to the selected theme 310, the host computer 12 may interrogate one or more of the electronic data sources 17 to retrieve the descriptive data provided therein to a user via the display 200 such that the user may be better informed when initiating revising user inputs (as described above) for finalizing the interactive itinerary 500. The host computer 12 may be capable of displaying the retrieved descriptive data in real time via the display 200 such that the user may be immediately and constantly informed of descriptive data that corresponds to the travel “experience” that the host computer 12 is assisting them in assembling.

As shown generally in FIG. 9, the descriptive data may be arranged in the display 200 as tabbed pages 342, 344, 346, 348, 343, and 345 that may supplement the main “packages” page 340 (shown generally in FIG. 3, for example) through which a user may navigate to make revising user inputs to finalize the interactive itinerary 500 that may be assembled by the host computer 12 in response to an initial user input. The tabbed pages may indicate the types of descriptive data available for a particular theme 310. For example, tab 342 may comprise full text and/or internet links to travel articles focused on Las Vegas travel. Tab 344 (the contents of which are shown generally in FIG. 9, for example) may comprise full text listings 910 and/or links to other users' online discussion of Las Vegas travel topics. Such listings 910 may include, but are not limited to: a “thread” or “journal” title 911 indicating the general travel topic; an identifier 912 (such as a user ID) for the user and/or peer that composed the thread or journal; a date 913 indicating the last time the “thread” and/or journal was modified (which may indicate how current the information may be); and an editor rating 914 wherein an operator of the system of the present invention may (using, for example, a keyboard interface 26 and dedicated display 26 in communication with the host computer 12) provide a third-party evaluation of the quality of the thread or journal. Other descriptive data may be available linked to tabs 346 and 348 which may include photos and video, respectively, associated with the selected theme 310 and/or destination. Tab 343 may contain, for example, city maps of a destination associated with a particular theme 310 that may supplement the interactive map display 800 that may be provided according to some embodiments of the present invention (as shown generally in FIG. 8). Tab 345 may comprise descriptive data associated with upcoming events in the region and/or city corresponding to the selected theme 310. According to various system embodiments of the present invention, the host computer 12 may be in communication (via the network 14) for example with various types of electronic data sources 17 that may include, but are not limited to; an internet discussion board; an internet journal; a photo database; a mapping and/or directions website; a destination guide; an online travel agency; an online travel reviews publication; a supplier-based sales channel; a supplier service information website; a third party seller site (such as, for example a consolidator service site and/or tour company website); a “distressed inventory” online outlet; an online travel agent; a local publication website corresponding to a selected destination; an event information source; a service company site (such as, for example a newspaper and/or mail delivery site); an electronic desktop source (such as, for example calendars and/or planning software); government websites (such as, for example, sites for passport renewal and/or travel warnings); concierge sites; telecommunication services sites; equipment rental service sites; luggage pickup or delivery service sites; pet and/or house sitting service sites; and/or combinations thereof.

As illustrated in exploded FIG. 1B, the host computer 12 of the system embodiments of the present invention may be generally embodied as a typical computer, server or mainframe system depending on the embodiment. The host computer 12 may generally include a processing element 20, such as a microprocessor, VLSI, ASIC, etc., a storage device 22, display 24, keyboard and mouse interface 26, and a network interface 28.

In some embodiments, the host computer system 12 may poll one or more reservation systems 16 for travel product availability, scheduling and/or location data, and/or theme data corresponding to various travel products made available via the reservation systems 16 each time a user enters a user input (via a personal computer 18, for example). However, in some embodiments, such frequent availability and retrieval requests may slow down and/or disrupt the reservation system 16. Further, accessing the reservation system 16 may have an associated processing delay. For this reason, in some embodiments, the host computer 12 may further include a prepopulated cache 30 from which travel product availability information and supplemental data corresponding to particular travel products is derived for providing responses to user inputs (and for assembly the interactive itinerary 500 according to various embodiments of the present invention. Specifically, as shown in FIG. 1B, the host computer system 12 of the present invention includes an availability cache 30 located in the storage device 22. The availability cache 30 is populated with various travel product information and corresponding supplemental data needed to properly respond to user inputs (such as the selection of a selected destination and/or travel theme 310). In such embodiments, the supplemental data retrieved from the availability cache 30 may also be used to assemble and/or update an interactive itinerary 500, as described above, and be presented to the user's personal computer 18 in a website display 200.

Furthermore, according to various system embodiments of the present invention, it should be understood that travel product availability and/or supplemental data (including, in some examples scheduling, location, and/or theme data corresponding to particular travel products) may be transferred from one or more reservation systems 16 to the host computer 12 (or a storage device 22 in communication therewith) via “push” and/or “pull” techniques. For example, according to “pull” techniques, one skilled in the art will appreciate that the host computer 12 may periodically (in response to a user input, and/or at a predetermined interval, for example) interrogate one or more reservation systems 16 to “pull” travel product availability data and/or supplemental data therefrom. Furthermore, according to other system embodiments, “push” techniques may be used, wherein one or more reservation systems 16 may be adapted to periodically “push” travel product availability data and/or supplemental data to the host computer 12 (via a network 14 connection, for example) and/or to the storage device 22 that may be included as a component of the host computer 12 of the present invention. Thus, as described above, either of the described “pull” or “push” techniques may also be used to populate an availability cache 30 provided as part of the host computer 12. As one skilled in the art will appreciate, similar “push” and/or “pull” techniques may also be used to transfer descriptive data from one or more electronic data sources 17 to the host computer 12 (via a network 14, for example). In addition, similar “push” and/or “pull” techniques may also be used to transfer user preference data from a user's personal computer 18 to the host computer 12 such that the host computer 12 may more easily “learn” a specific user's preferences and thus be more capable of building a travel “experience” and corresponding interactive itinerary that meets a specific user's needs.

The various operations of the present invention may be performed either by hardware in the form of ASIC chips or other specialized hardware or by operation of software ran by a processing element. In the latter case, the storage device 22 may also further include the various computer software programs and modules used to implement the operations of the present invention.

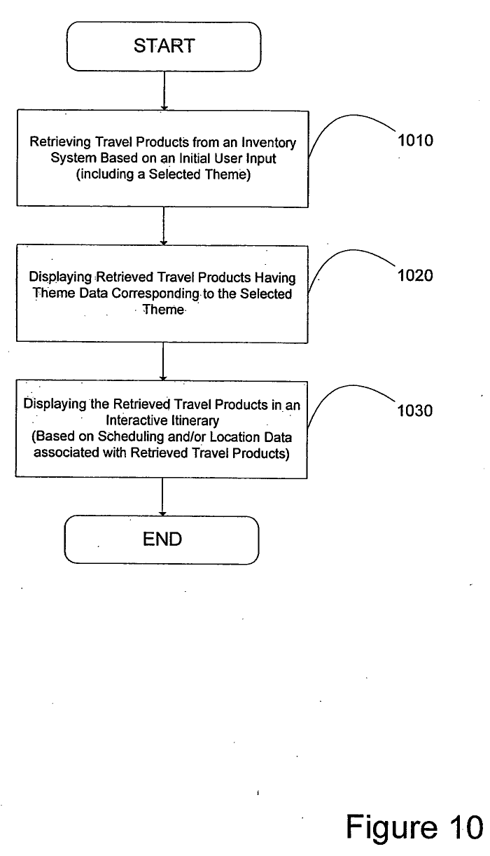

Some embodiments of the present invention further provide methods for assembling and displaying a travel itinerary (such as the interactive itinerary 500 described generally above) comprising a plurality of travel products selected from a database based on a selected theme 310 in a manner that reduces the burden on an inventory system. The inventory system may comprise travel products, wherein for at least some of the travel products, the inventory system further comprises scheduling and/or location data corresponding to the travel products and theme data corresponding to the travel products. FIGS. 10-15 show some exemplary embodiments of the present invention. For example, as shown generally in FIG. 10, the method embodiments of the present invention may comprise: step 1010 for retrieving travel products from an inventory system (such as one or more reservation systems 16) based on an initial user input, wherein the initial user input comprises a selected theme 310, step 1020 for displaying to the user retrieved travel products having theme data corresponding to the selected theme, and step 1030 for displaying the retrieved travel products in an interactive itinerary 500 (see FIG. 5, for example) based at least in part on the scheduling and/or location data and the selected theme 310 for retrieved travel products having corresponding scheduling and/or location data.

As described above with respect to the system embodiments of the present invention, the initial user input may also comprise the input of a selected departure location 210 and/or travel dates 215. In response to such an initial user input, the method embodiments of the present invention may further comprise generating a display 200 (see FIG. 3, for example) including a plurality of themes 310 that may correspond to travel products retrieved from various reservation systems 16 that may comply with the initial user input. Using the interactive display 200 of FIG. 3, a user may further input an initial user input that may comprise a selected theme 310 (see FIG. 10, step 1010). Thus, in response to the input of an initial user input including a selected theme 310, the method embodiments of the present invention may further comprise step 1010 for retrieving travel products from an inventory system (such as one or more reservation systems 16) based on the initial user input and steps 1020 and 1030 as described above for assembling and displaying an interactive itinerary 500 (as shown generally in FIG. 5, for example).

Some method embodiments of the present invention may also comprise a step for detecting an idle time period within the interactive itinerary (such as a time period during which no travel products are scheduled) and a step for displaying a suggested travel product in an interactive display (such as a “pop-up” text box similar to the interactive graphic shown as element 710 in FIG. 7). In some method embodiments, the displaying a suggested travel product step may comprise displaying a suggested travel product having scheduling data substantially corresponding to the idle time period. For example, as shown in FIG. 5, the method may comprise proposing(via a text and/or “pop-up” graphic) a suggested travel product (such as, for example, a dinner reservation prior to the show reservation 540 shown generally on “Sunday the 8^{th}”) to fill a detected idle time period within the interactive itinerary 500. Thus, some method embodiments of the present invention may provide users with the opportunity to fill idle time periods with time-appropriate travel products. For example, the method may comprise displaying suggested dinner reservations during idle time periods that may fall during traditional meal times.

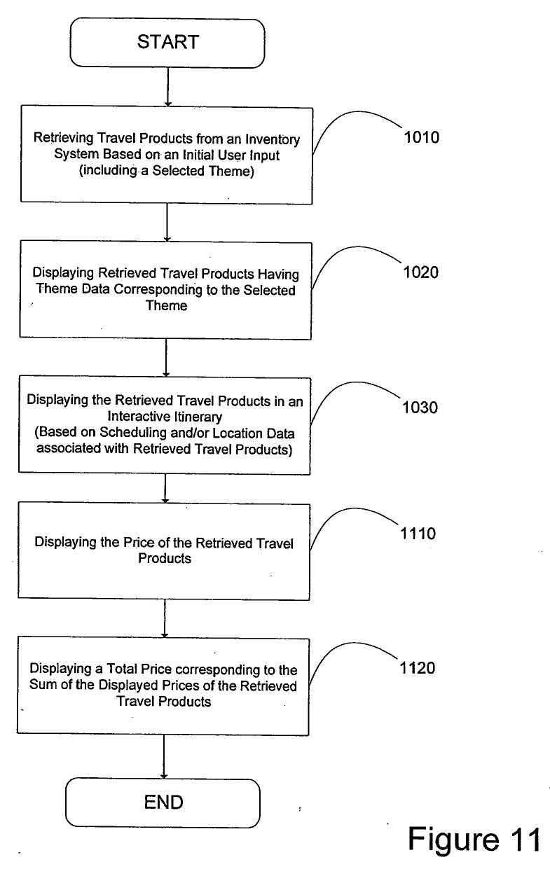

According to some method embodiments, as shown, for example in FIG. 11, the method of the present invention may further comprise step 1110 for displaying the price of each individual travel product retrieved from one or more reservation systems 16 in step 1010. Furthermore, the method may also comprise displaying a total price (such as the cumulative price 315 shown in the display 200 of FIGS. 3-5) corresponding to the sum of the displayed prices of the retrieved travel products. Thus, the method embodiments of the present invention may comprise displaying the price of individual travel products (such as the various shows or entertainment products shown in an itemized format in the “shows” shopping cart 610 display of FIG. 6, for example) as well as calculating and displaying the cumulative price 315 of all the travel products included as part of an interactive itinerary 500 (which may include, airline itinerary cost, hotel cost, car rental cost, and/or other travel costs associated with the complete interactive itinerary 500). Thus, according to such method embodiments, a user may be made aware of the cost impact of the removal or addition of selected travel products to the interactive itinerary 500. According to some embodiments, the method may further comprise displaying a plurality of interactive icons (such as check boxes, for example) corresponding to each of the travel products displayed in the interactive itinerary 500, detecting a user selection of at least one of the interactive icons, and subsequently calculating the total price (and/or cumulative price 315 as described above) based on the sum of the displayed prices of the selected retrieved travel products. Thus, according to such method embodiments, a user may highlight the cost effect of including and/or excluding the costs of certain travel products from the interactive itinerary 500 in order to weigh the value of such products relative to the cumulative price 315 of the interactive itinerary 500.

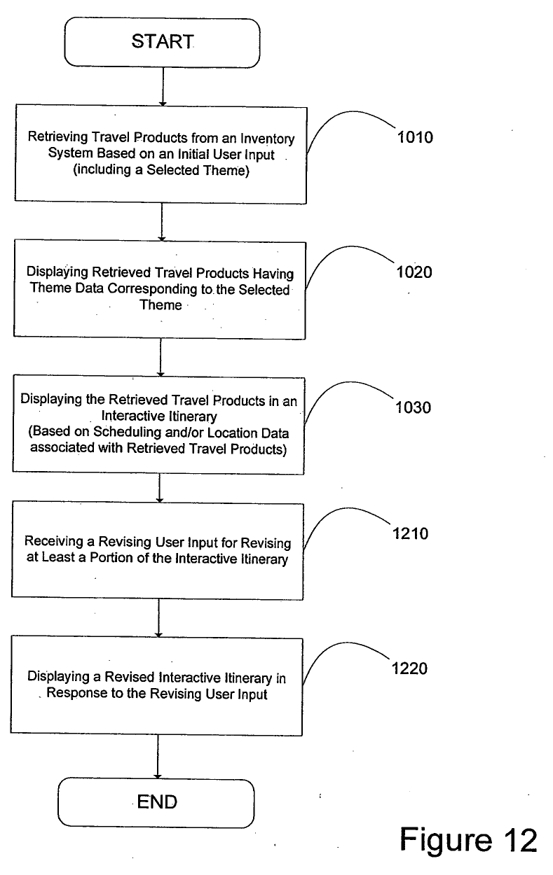

Furthermore, and as described generally above with respect to the system embodiments of the present invention, the host computer 12 of the system of the present invention may be capable of retrieving travel products from an inventory system (such as, for example, one or more reservation systems 16) having the lowest price corresponding to the selected theme 310. Similarly, the method embodiments of the present invention (for example, the retrieving step 1010, shown in FIG. 10), may further comprise retrieving travel products from one or more reservation systems 16 having the lowest available price while still corresponding to the selected theme. For example, for a “Las Vegas” weekend theme, the method may comprise retrieving the lowest-cost hotel accommodations available that are within walking distance to the casinos located on “the strip” in Las Vegas. As described in further detail below with respect to FIG. 12, a user may also input a revising user input to change the lower limit and/or upper limit for hotel accommodation costs and/or other travel product costs and/or ratings (see elements 320, 325, 327 of FIG. 3, for example, showing user input “slider bars” for receiving a revising user input for changing the length of stay, hotel rating (i.e., number of “stars”), and/or maximum cumulative price 315). Thus, the retrieving the lowest-price travel product step may be adjusted to retrieve the lowest-price travel product that complies with one or more received revising user inputs.

FIG. 12 shows another method embodiment of the present invention comprising step 1210 for receiving a revising user input for revising at least a portion of the interactive itinerary 500 (and, in some cases the cumulative price 315 associated therewith), and step 1220 for displaying a revised interactive itinerary 500 in response to the received revising user input. For example, in some method embodiments, at least one of the plurality of travel products listed in the interactive itinerary 500 (see FIG. 5) may include a hotel room reservation for a selected number of nights (see hotel check-in 521a and hotel check-out 521b indicators shown in the interactive itinerary, for example). According to some method embodiments, the receiving a revising user input step 1220 may further comprises receiving a revising user input including, but not limited to: a selection of a number of guests; a selection of a hotel room class; a selection of a number of nights (which may, in some embodiments be accomplished by “dragging and dropping” the check-in indicator 521a and/or check-out indicator 521b to an alternate day in the interactive itinerary 500); a selection of a hotel company; a selection of a hotel class (see the hotel class slider bar 325 in FIG. 3, for example); and combinations of the above revising user inputs. The method may comprise, in some embodiments, receiving a revising user input on a specialized hotel selection display 200 (see FIG. 8, for example, which may include interactive icons for selecting a room type 815 and/or selecting a particular hotel property from an interactive map display 800 (see further discussion below) that may be capable of mapping various hotels relative to other scheduled travel products listed in the interactive itinerary 500.

According to some additional method embodiments, the travel product retrieved in the retrieving step 1010 may comprise a reserved ticket for an entertainment product (such as a Las Vegas show, for example). In some such method embodiments, the receiving a revising user input step 1210 may further comprise receiving a revising user input that may include, but is not limited to: a selection of a number of tickets; a selection of a show time for the show; a selection of a show; a selection of a class of ticket; and combinations of the above-listed revising user inputs corresponding to an entertainment activity. For example, as shown in FIG. 6, step 1210 for receiving a revising user input may comprise receiving the selection of one or more shows 630 by detecting a user actuation of one or more interactive icons 635 for selecting a particular show and/or a particular number of tickets for a show. According to other method embodiments, the receiving a revising user input 1210 may also trigger the display of a revised interactive itinerary according to step 1220 discussed above. In such embodiments, the selection of a particular show (see FIG. 6) may be indicated in a shopping cart 610 display that may also include a status display 615 for informing a user of the balance of “show credit” remaining (in cases wherein the travel products in the shopping cart 610 have individual prices that, in sum, are less than the apportioned “show credit included as part of a selected interactive itinerary 500). As shown in FIG. 6, the status display 615 may also indicate the premium owed by the user (i.e., the cost exceeding the quoted cumulative price 315 of the primary interactive itinerary (see element 315, FIG. 3) due to the selection of shows (or other travel products) that exceed the allotted “show credit.” As described above with respect to the system embodiments of the present invention, the host computer 12 may also be capable of updating the shopping cart 610 and/or status display 615 of the “shows” display in accordance with revising user inputs (received via a number of show selection buttons 635 that may be displayed adjacent to corresponding show options 630). Thus, the displaying a revised interactive itinerary step 1220 may further comprise displaying a revised interactive itinerary 500 including additional selected shows and/or displaying a revised interactive itinerary 500 including an updated cumulative price 315 corresponding to the premium owed, and/or “show credit” balance remaining as indicated by the status display 615.

According to other method embodiments of the present invention, the retrieved travel products may include an airline itinerary. According to such embodiments, step 1210 for receiving a revising user input may comprise receiving a revising user input that may include, but is not limited to: a selection of a number of passengers; a selection of a departure date; a selection of a departure time; a selection of a return date; a selection of a return time; a selection of a departure location; a selection of a destination; a selection of an airline; a selection of a seating class; a selection of a fare code; and combinations thereof. In method embodiments wherein at least one of the retrieved travel products is a reservation for a recreational activity (such as a golf tee time and/or a whitewater rafting excursion, for example), step 1210 for receiving a revising user input may comprise receiving a revising user input that may include, but is not limited to: a selection of an equipment rental; a selection of an activity date and time; a selection of a number of people; and combinations thereof. Similarly, in method embodiments wherein at least one of the retrieved travel products is a car rental, step 1210 for receiving a revising user input may comprise receiving a revising user input that may include, but is not limited to: a selection of a car rental pick-up date; a selection of a car rental drop-off date; a selection of a car rental pick-up location; a selection of a car rental drop-off location; a selection of a car class; a selection of car rental company; and combinations thereof. According to various method embodiments including steps 1210 and 1220 (see FIG. 12) for receiving a revising user input and displaying a revised interactive itinerary 500 in response to the receiving revising user input, the receiving step 1210 may comprise detecting a “drag and drop” operation initiation by the user using, for example, a “click and drag” computer mouse operation, to select and/or move one or more of the retrieved travel products to one or more alternate dates and/or times within the interactive itinerary 500 (shown, for example, in FIG. 5). In addition, the displaying a revised interactive itinerary step 1220 may comprise not only revising the cumulative price 315 of the interactive itinerary 500 but also adjusting other time and/or date-dependent travel products (and their prices) accordingly. For example, if the receiving a revising user input step 1210 comprises the selection of alternate dates for the flight departure and/or flight arrival indicators (520a and 520b, for example), step 1220 may comprise displaying a revised interactive itinerary 500 (including a revising cumulative price 315, for example) wherein the hotel check-in and hotel check-out indicators (521a and 521b, for example) are shifted to the newly selected flight departure and arrival dates.

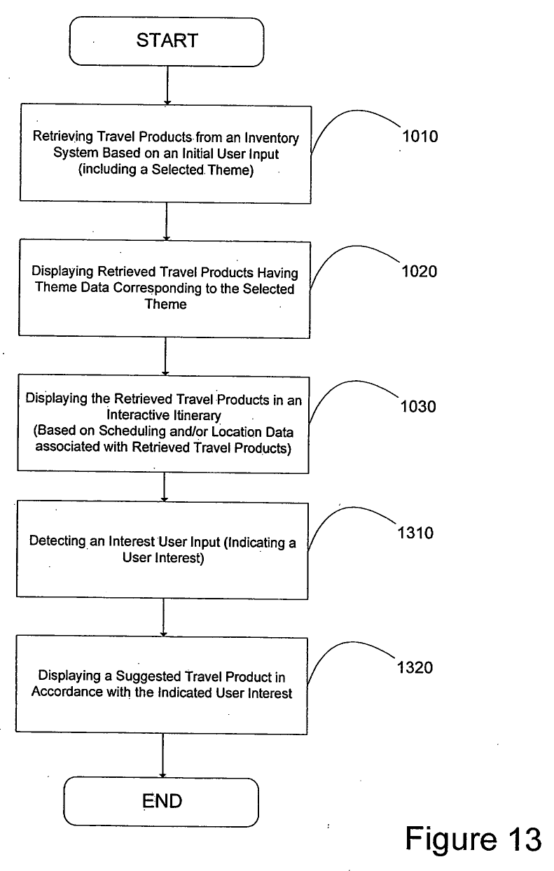

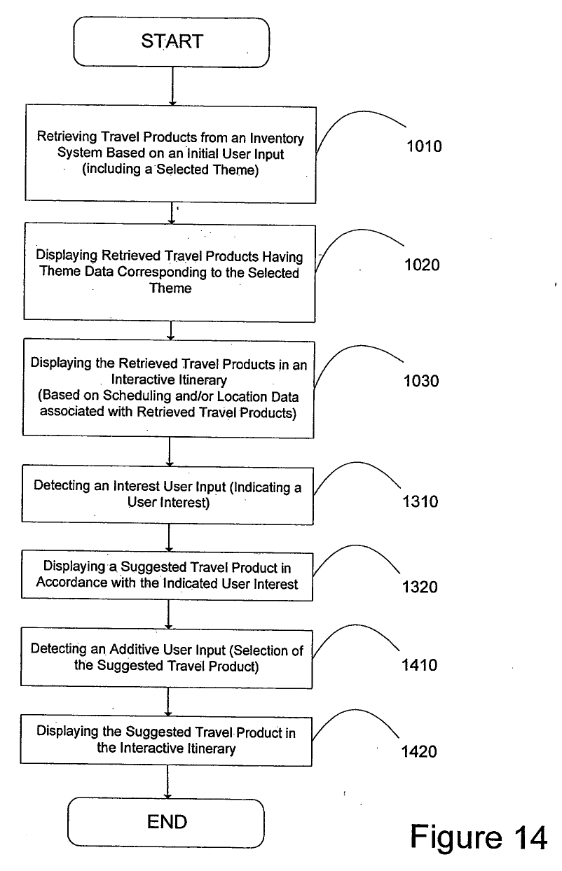

FIG. 13 shows another alternative method embodiment of the present invention comprising the retrieving travel products 1010, displaying retrieved travel products 1020, and displaying an interactive itinerary 1030 steps discussed above, and additional step 1310 for detecting an interest user input, the interest user input indicating a user interest; and step 1320 for displaying a suggested travel product in an interactive display in accordance with the indicated user interest. For example, as shown in FIG. 7, the method may detect (in step 1310, for example) a number of user clicks and/or other selections that may be indicative of a user interest in a particular genre and/or type of show or other entertainment travel product (such as the selection of one or more shows 630 listed in the display 200 shown in FIG. 6, for example). In response to the detected user interest, the method may comprise step 1320 for displaying a suggested travel product (such as a similar show type, and/or a second show that other users have selected who have similar indicated user interests to the present user). For example, step 1320 may comprise presenting the suggested travel product via an interactive display 710 that may comprise one or more user input buttons 711, 713 for declining or selecting, respectively, the suggested travel product. In addition, as shown generally in FIG. 14 method may further comprise step 1410 for receiving an additive user input (such as the actuation of the “acceptance” user input button 713) and step 1420 for updating the interactive itinerary 500 (and/or the “shows” shopping cart 610, of FIG. 6, for example) to display the suggested travel product (the suggested show, for example) in the interactive itinerary 500 in response to the detected additive user input.

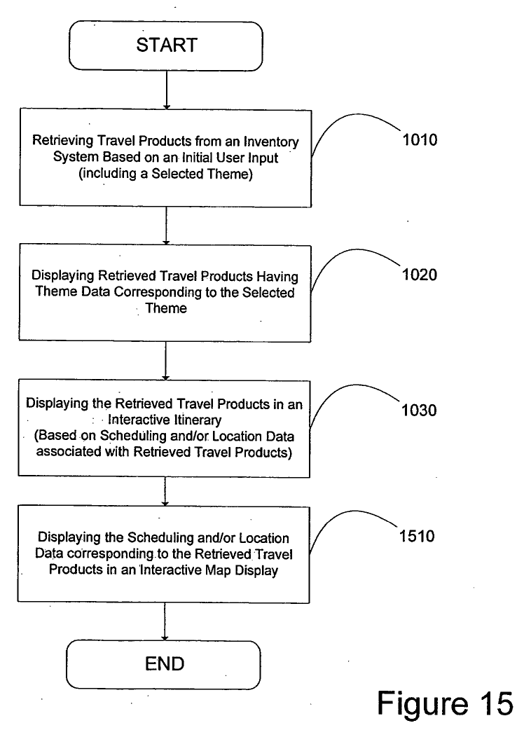

In order to provide a user with a geographical and/or logistical perspective of a destination for the interactive itinerary 500, the method embodiments of the present invention may also comprise steps for displaying the locations of travel products (such as hotels, entertainment venues, and/or other airports, for example) in a map display (see FIG. 8, element 800, for example). FIG. 15 illustrates the steps of one such exemplary method embodiment that may comprise step 1510 for displaying the scheduling and/or location data corresponding to the retrieved travel products in an interactive map display 800. According to some embodiments, the interactive map display 800 displayed in step 1510 may allow a user to input a revising user input (such as the selection of an alternate hotel that may be in closer proximity to a majority of the locations for the other travel products included in an interactive itinerary 500. The interactive map display 800 generated in step 1510, for example, may also comprise interactive icons 830 for allowing a user to “map shows” and/or to map other travel products and/or travel activities relative to a plurality of hotel options by selecting a check box or other interactive icon, for example, such that the user may, in real-time, view the logistical and geographical considerations associated with their travel experience.

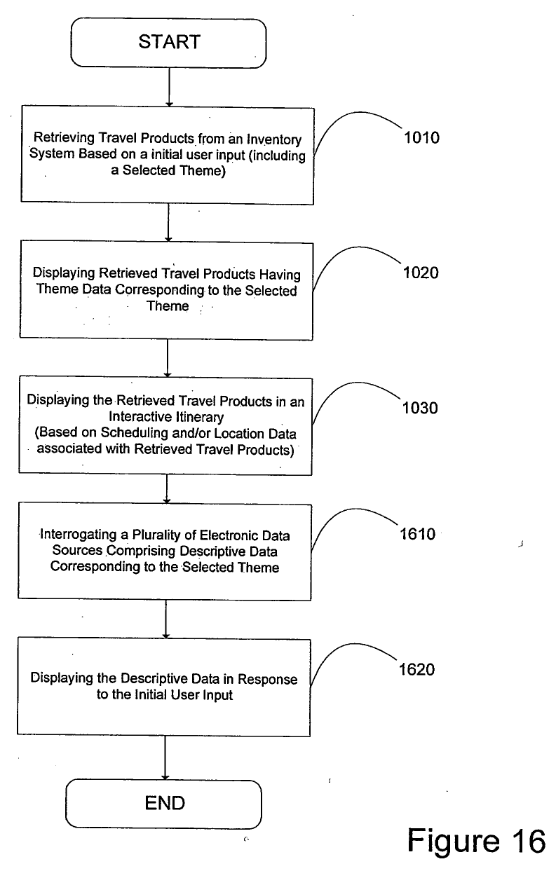

Furthermore, other method embodiments as shown generally in FIG. 16, may further comprise method steps for providing descriptive data to a user that may correspond to a selected travel theme 310 and/or a destination associated with a selected travel theme 310 such that a user may have the benefit of such descriptive data when entering revising user inputs (see FIG. 12, step 1210, for example) to amend and/or finalize the interactive itinerary 500. For example, as shown in FIG. 16, one method embodiment may further comprise step 1610 for interrogating a plurality of electronic data sources 17 (in communication with a host computer 12, via a network 14 (such as the internet), for example) comprising descriptive data corresponding to the selected theme 310, and step 1620 for displaying the descriptive data in response to the initial user input (via a display 200, such as the descriptive data display shown generally in FIG. 9 wherein various categories of descriptive data may be organized by tabbed electronic pages). According to some embodiments, the electronic data sources interrogated in step 1610 may include, but are not limited to: an internet discussion board; an internet journal; a photo database; a mapping and/or directions website; a destination guide; an online travel agency; an online travel review publication (including professional travel reviews); a supplier-based sales channel; a supplier service information website; a third party seller site (such as, for example a consolidator service site and/or tour company website); a “distressed inventory” online outlet; an online travel agent; a local publication website corresponding to a selected destination; an event information source; a service company site (such as, for example a newspaper and/or mail delivery site); an electronic desktop source (such as, for example calendars and/or planning software); government websites (such as, for example, sites for passport renewal and/or travel warnings); concierge sites; telecommunication services sites; equipment rental service sites; luggage pickup or delivery service sites; pet and/or house sitting service sites; and/or combinations thereof. Furthermore, as shown generally in FIG. 9, the descriptive data retrieved from the electronic data sources 17 (see FIG. 1B), may be arranged by tabs such that a user may easily navigate and view the descriptive data corresponding to the selected theme 310 (and/or a destination corresponding to a selected theme 310). For example, the descriptive data may include, but is not limited to: travel articles prepared by professional journalists and/or reviewers (displayed under tab 342, for example); discussions (such as internet threads, journals, and/or “blogs” generated by other users) (displayed under tab 344, for example); photos of a selected destination and/or theme 310 (displayed under tab 346, for example); video clips of a selected destination and/or theme 310 (displayed under tab 348, for example); maps of a selected destination (displayed under tab 343, for example); and a calendar and/or listing of events occurring at or near a selected destination and/or in conjunction with a selected theme 310 (displayed under tab 345, for example). The descriptive data may also include, but is not limited to: information related to a destination; information related to travel arrangements; information related to reservations and/or rentals; information related to government-issued travel documents and/or advisories; and other descriptive data corresponding to the selected theme and/or travel products.

In addition to providing apparatus and methods, the present invention also provides computer program products for performing the operations described above. The computer program products have a computer readable storage medium having computer readable program code means embodied in the medium. With reference to FIG. 1B, the computer readable storage medium may be part of the storage device 22, not shown, and may implement the computer readable program code means to perform the above discussed operations.

In this regard, FIGS. 10-16 are block diagram illustrations of methods, systems and program products according to the invention. It will be understood that each block or step of the block diagram and combinations of blocks in the block diagram can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for assembling and displaying a travel itinerary comprising a plurality of travel products selected from a database based on a selected theme in a manner that reduces the burden on inventory systems, the system comprising:
an inventory system comprising travel products wherein for at least some of the travel products said inventory system further comprises scheduling and/or location data corresponding to the travel products and theme data corresponding to the travel products; and
a host computing element in communication with said inventory system for running queries on said inventory system based on a initial user input, the initial user input comprising the selected theme;
wherein said host computing element retrieves travel products from said inventory system having theme data corresponding to the selected theme of the user input and displays retrieved travel products corresponding to the selected theme, and
wherein for those retrieved travel products having scheduling and/or location data corresponding to the retrieved travel products, said host computing element displays the retrieved travel products in an interactive itinerary based at least in part on the scheduling and/or location data and the selected theme.

2. A system according to claim 1, wherein said host computing element detects an idle time period within the interactive itinerary; and wherein said host computing element displays a suggested travel product in an interactive display, the suggested travel product having scheduling data substantially corresponding to the idle time period.

3. A system according to claim 1, wherein said inventory system further comprises pricing data representing a price corresponding to the travel products, and wherein said host computing element further displays the price of the retrieved travel products in the interactive itinerary and a total price corresponding to the sum of the displayed prices of the retrieved travel products.

4. A system according to claim 3, wherein said host computing element further displays a plurality of interactive icons corresponding to each of the retrieved travel products displayed in the interactive itinerary, and wherein said host computing element further detects a user selection of at least one of the plurality of interactive icons and wherein said host computing element calculates and displays the total price based on the sum of the displayed prices of the selected retrieved travel products.

5. A system according to claim 3, wherein said host computing element further retrieves travel products from said inventory system having the lowest price corresponding to the selected theme.

6. A system according to claim 1, wherein said host computing element further receives a revising user input for revising at least a portion of the interactive itinerary and wherein the said host computing element further displays a revised interactive itinerary in response to the received revising user input.

7. A system according to claim 6, wherein at least one of the plurality of travel products is a hotel room for a selected number of nights, and wherein the received revising user input comprises at least one of:
a selection of a number of guests;
a selection of a hotel room class;
a selection of a number of nights;
a selection of a hotel company;
a selection of a hotel class; and
combinations thereof.

8. A system according to claim 6, wherein at least one of the plurality of travel products is a reserved ticket for a show, and wherein the received revising user input comprises at least one of:
a selection of a number of tickets;
a selection of a show time for the show;
a selection of a show;
a selection of a class of ticket; and
combinations thereof.

9. A system according to claim 6, wherein at least one of the plurality of travel products is an airline itinerary, and wherein the received revising user input comprises at least one of:
a selection of a number of passengers;
a selection of a departure date;
a selection of a departure time;
a selection of a return date;
a selection of a return time;
a selection of a departure location;
a selection of a destination;
a selection of an airline;
a selection of a seating class;
a selection of a fare code; and
combinations thereof.

10. A system according to claim 6, wherein at least one of the plurality of travel products is a reservation for a recreational activity, and wherein the received revising user input is at least one of:
a selection of an equipment rental;
a selection of an activity date and time;
a selection of a number of people; and
combinations thereof.

11. A system according to claim 6, wherein at least one of the plurality of travel products is a car rental, and wherein the received revising user input is at least one of:
a selection of a car rental pick-up date;
a selection of a car rental drop-off date;
a selection of a car rental pick-up location;
a selection of a car rental drop-off location;
a selection of a car class;
a selection of car rental company; and
combinations thereof.

12. A system according to claim 1, wherein said host computing element further detects an interest user input, the interest user input indicating a user interest; and wherein said host computing element displays a suggested travel product in an interactive display in accordance with the indicated user interest.

13. A system according to claim 12, wherein said host computing element further detects a additive user input, the additive user input comprising a selection of the suggested travel product; and wherein said host computing element displays the suggested travel product in the interactive itinerary in response to the detected additive user input.

14. A system according to claim 1, wherein said host computing element further displays the scheduling and/or location data corresponding to the retrieved travel products in an interactive map display.

15. A system according to claim 1, wherein said host computing element further interrogates a plurality of electronic data sources comprising descriptive data corresponding to the selected theme, and wherein said host computing element further displays the descriptive data in response to the user input.

16. A system according to claim 15, wherein the plurality of electronic data sources comprise at least one of:
an internet discussion board;
an internet journal;
a photo database;
a mapping and/or directions website;
a government website;
a destination guide; and
combinations thereof.

17. A method for assembling and displaying a travel itinerary comprising a plurality of travel products selected from a database based on a selected theme in a manner that reduces the burden on an inventory system, the inventory system comprising travel products wherein for at least some of the travel products said inventory system further comprises scheduling and/or location data corresponding to the travel products and theme data corresponding to the travel products, the method comprising:
retrieving travel products from an inventory system based on an initial user input, the initial user input comprising a selected theme;
displaying to the user retrieved travel products having theme data corresponding to the selected theme;
displaying the retrieved travel products in an interactive itinerary based at least in part on the scheduling and/or location data and the selected theme for those retrieved travel products having corresponding scheduling and/or location data.

18. A method according to claim 17, further comprising:
detecting an idle time period within the interactive itinerary; and
displaying a suggested travel product in an interactive display, the suggested travel product having scheduling data substantially corresponding to the idle time period.

19. A method according to claim 17, wherein the inventory system further comprises pricing data representing a price corresponding to the travel products, the method further comprising:
displaying the price of the retrieved travel products in the interactive itinerary; and
displaying a total price corresponding to the sum of the displayed prices of the retrieved travel products.

20. A method according to claim 19, further comprising:
displaying a plurality of interactive icons corresponding to each of the retrieved travel products displayed in the interactive itinerary;
detecting a user selection of at least one of the plurality of interactive icons;
calculating the total price based on the sum of the displayed prices of the selected retrieved travel products; and
displaying the calculated total price.

21. A method according to claim 19, further comprising retrieving travel products from the inventory system having the lowest price corresponding to the selected theme.

22. A method according to claim 17, further comprising:
receiving a revising user input for revising at least a portion of the interactive itinerary; and
displaying a revised interactive itinerary in response to the received revising user input.

23. A method according to claim 22, wherein at least one of the plurality of travel products is a hotel room for a selected number of nights, and wherein receiving a revising user input step further comprises receiving a revising user input comprising at least one of:
a selection of a number of guests;
a selection of a hotel room class;
a selection of a number of nights;
a selection of a hotel company;
a selection of a hotel class; and
combinations thereof.

24. A method according to claim 22, wherein at least one of the plurality of travel products is a reserved ticket for a show, and wherein receiving a revising user input step further comprises receiving a revising user input comprising at least one of:
a selection of a number of tickets;
a selection of a show time for the show;
a selection of a show;
a selection of a class of ticket; and
combinations thereof.

25. A method according to claim 22, wherein at least one of the plurality of travel products is an airline itinerary, and wherein receiving a revising user input step further comprises receiving a revising user input comprising at least one of:
a selection of a number of passengers;
a selection of a departure date;
a selection of a departure time;
a selection of a return date;
a selection of a return time;
a selection of a departure location;
a selection of a destination;
a selection of an airline;
a selection of a seating class;
a selection of a fare code; and
combinations thereof.

26. A method according to claim 22, wherein at least one of the plurality of travel products is a reservation for a recreational activity, and wherein receiving a revising user input step further comprises receiving a revising user input comprising at least one of:
a selection of an equipment rental;
a selection of an activity date and time;
a selection of a number of people; and
combinations thereof.

27. A method according to claim 22, wherein at least one of the plurality of travel products is a car rental, and wherein receiving a revising user input step further comprises receiving a revising user input comprising at least one of:
a selection of a car rental pick-up date;
a selection of a car rental drop-off date;
a selection of a car rental pick-up location;
a selection of a car rental drop-off location;
a selection of a car class;
a selection of car rental company; and
combinations thereof.

28. A method according to claim 17, further comprising:
detecting an interest user input, the interest user input indicating a user interest; and
displaying a suggested travel product in an interactive display in accordance with the indicated user interest.

29. A method according to claim 28, further comprising:
detecting a additive user input, the additive user input comprising a selection of the suggested travel product; and
displaying the selected suggested travel product in the interactive itinerary in response to the detected additive user input.

30. A method according to claim 17, further comprising displaying the scheduling and/or location data corresponding to the retrieved travel products in an interactive map display.

31. A method according to claim 17, further comprising:
interrogating a plurality of electronic data sources comprising descriptive data corresponding to the selected theme; and
displaying the descriptive data in response to the initial user input.

32. A method according to claim 31, wherein the interrogating step further comprises interrogating a plurality of electronic data sources comprising at least one of:
an internet discussion board;
an internet journal;
a photo database;
a government website;
a mapping and/or directions website;
a destination guide; and
combinations thereof.

33. A computer program product for assembling and displaying a travel itinerary comprising a plurality of travel products selected from a database based on a selected theme in a manner that reduces the burden on an inventory system, the inventory system comprising travel products wherein for at least some of the travel products said inventory system further comprises scheduling and/or location data corresponding to the travel products and theme data corresponding to the travel products, the computer program product comprising a computer-readable storage medium having computer-readable program code instructions stored therein comprising:
first computer instruction means for retrieving travel products from an inventory system based on an initial user input, the initial user input comprising a selected theme;
second computer instruction means for displaying to the user retrieved travel products having theme data corresponding to the selected theme;
third computer instruction means for displaying the retrieved travel products in an interactive itinerary based at least in part on the scheduling and/or location data and the selected theme for those retrieved travel products having corresponding scheduling and/or location data.

34. A computer program product according to claim 33, wherein the inventory system further comprises pricing data representing a price corresponding to the travel products, the computer program product further comprising:
fourth computer instruction means for displaying the price of the retrieved travel products in the interactive itinerary; and
fifth computer instruction means for displaying a total price corresponding to the sum of the displayed prices of the retrieved travel products.

35. A computer program product according to claim 34, further comprising:
sixth computer instruction means for displaying a plurality of interactive icons corresponding to each of the retrieved travel products displayed in the interactive itinerary;
seventh computer instruction means for detecting a user selection of at least one of the plurality of interactive icons;
eighth computer instruction means for calculating the total price based on the sum of the displayed prices of the selected retrieved travel products; and
ninth computer instruction means for displaying the calculated total price.

36. A computer program product according to claim 34, further comprising tenth computer instruction means for retrieving travel products from the inventory system having the lowest price corresponding to the selected theme.

37. A computer program product according to claim 33, further comprising:
eleventh computer instruction means for receiving a revising user input for revising at least a portion of the interactive itinerary; and
twelfth computer instruction means for displaying a revised interactive itinerary in response to the received revising user input.

38. A computer program product according to claim 37, wherein at least one of the plurality of travel products is a hotel room for a selected number of nights, and wherein the eleventh computer instruction means for receiving a revising user input further comprises thirteenth computer instruction means for receiving a revising user input comprising at least one of:
a selection of a number of guests;
a selection of a hotel room class;
a selection of a number of nights;
a selection of a hotel company;
a selection of a hotel class; and
combinations thereof.

39. A computer program product according to claim 37, wherein at least one of the plurality of travel products is a reserved ticket for a show, and wherein the eleventh computer instruction means for receiving a revising user input further comprises fourteenth computer instruction means for receiving a revising user input comprising at least one of:
a selection of a number of tickets;
a selection of a show time for the show;
a selection of a show;
a selection of a class of ticket; and
combinations thereof.

40. A computer program product according to claim 37, wherein at least one of the plurality of travel products is an airline itinerary, and wherein the eleventh computer instruction means for receiving a revising user input further comprises fifteenth computer instruction means for receiving a revising user input comprising at least one of:
a selection of a number of passengers;
a selection of a departure date;
a selection of a departure time;
a selection of a return date;
a selection of a return time;
a selection of a departure location;
a selection of a destination;
a selection of an airline;
a selection of a seating class;
a selection of a fare code; and
combinations thereof.

41. A computer program product according to claim 37, wherein at least one of the plurality of travel products is a reservation for a recreational activity, and wherein the eleventh computer instruction means for receiving a revising user input further comprises sixteenth computer instruction means for receiving a revising user input comprising at least one of:
a selection of an equipment rental;
a selection of an activity date and time;
a selection of a number of people; and
combinations thereof.

42. A computer program product according to claim 37, wherein at least one of the plurality of travel products is a car rental, and wherein the eleventh computer instruction means for receiving a revising user input further comprises seventeenth computer instruction means for receiving a revising user input comprising at least one of:
a selection of a car rental pick-up date;
a selection of a car rental drop-off date;
a selection of a car rental pick-up location;
a selection of a car rental drop-off location;
a selection of a car class;
a selection of car rental company; and
combinations thereof.

43. A computer program product according to claim 33, further comprising:
eighteenth computer instruction means for detecting an interest user input, the interest user input indicating a user interest; and
nineteenth computer instruction means for displaying a suggested travel product in an interactive display in accordance with the indicated user interest.

44. A computer program product according to claim 43, further comprising:
twentieth computer instruction means for detecting an additive user input, the additive user input comprising a selection of the suggested travel product; and
twenty-first computer instruction means for displaying the selected suggested travel product in the interactive itinerary in response to the detected additive user input.

45. A computer program product according to claim 33, further comprising twenty-second computer instruction means for displaying the scheduling and/or location data corresponding to the retrieved travel products in an interactive map display.

46. A computer program product according to claim 33, further comprising:
twenty-third computer instruction means for interrogating a plurality of electronic data sources comprising descriptive data corresponding to the selected theme; and
twenty-fourth computer instruction means for displaying the descriptive data in response to the initial user input.

47. A computer program product according to claim 46, wherein the twenty-third computer instruction means for interrogating further comprises twenty-fifth computer instruction means for interrogating a plurality of electronic data sources comprising at least one of:
an internet discussion board;
an internet journal;
a photo database;
a government website;
a mapping and/or directions website;
a destination guide; and
combinations thereof.

48. A computer program product according to claim 33, further comprising:
twenty-sixth computer instruction means for detecting an idle time period within the interactive itinerary; and
twenty-seventh computer instruction means for displaying a suggested travel product in an interactive display, the suggested travel product having scheduling data substantially corresponding to the idle time period.
